(19) United States
(12) Patent Application Publication
(10) Pub. No.: US 2026/0301406 A1
(43) Pub. Date: Oct. 1, 2026

(54) SYSTEMS AND METHODS FOR GENERATING SPATIAL AUDIO TRACKS BY ANALYZING MEDIA CONTENT AND ASSOCIATED METADATA

(71) Applicant: Adeia Guides Inc., San Jose, CA (US)

(72) Inventors: Charles Dasher, Lawrenceville, GA (US); Reda Harb, Saint Petersburg, FL (US); Evgeny Kaminsky, Hollywood, FL (US); Aldis Sipolins, Somerville, MA (US)

(21) Appl. No.: 19/095,259

(22) Filed: Mar. 31, 2025

(51) Int. Cl. G06V 20/40; G10L 15/26; H04S 7/00

(52) U.S. Cl. CPC G06V 20/49; G06V 20/44; G10L 15/26; H04S 7/301

(57) ABSTRACT

Systems and methods for automatically generating spatial audio tracks for sound sources in a scene or segment of a media asset based on their surrounding physical, acoustic, and environmental conditions, are described. The methods perform video, audio, closed caption, and other contextual analysis to identify sound sources present in a selected scene of a pre-existing media asset. The identified sound sources are scored based on a plurality of factors, including their prominence and contextual relevance to the scene. Surroundings, such as structures (e.g., furniture and occlusions), ambient sounds, and sounds produced by other sound sources, are analyzed to determine their effect on the sound source. Spatial metadata is generated based on this analysis and surrounding context and is used to generate separate individual spatial audio tracks for each sound source that exceeds a relevance threshold.

### FIELD OF DISCLOSURE

Embodiments of the present disclosure relate to generating spatial audio tracks for sound sources identified within a media content item by automatically analyzing video, audio, closed captioning, and/or contextual information across scenes or segments of the media content item. The system evaluates environmental and acoustic factors such as reverberation, occlusion, and spatial location that influence how the identified sound sources should be rendered in the spatial audio mix.

### BACKGROUND

Spatialized sound is common across various industries, such as film, TV, music, video gaming (e.g., cloud gaming or local gaming where the game is installed on device such as gaming console), etc. Developers and creators of content manually perform spatialization of sound to create a more immersive and realistic listening experience that may allow a listener to get a feel of how we naturally perceive audio in the real world. For example, if a bird is tweeting on a tree branch in a forest, a conventional audio system (non-spatial) may simply render it as a general sound, preventing the user from fully perceiving where the sound is coming from or experiencing its full effect. In contrast, using existing methods, if the user were to manually spatialize that sound, the bird's tweeting may be precisely located within the three-dimensional (3D) soundscape, allowing the listener to fully experience the effect of the tweeting coming from, e.g., a specific tree branch high above and slightly to the right, understand the depth of the sound, and perceive its sound effects based on the environment, like what a user may see and hear in a highly professional film or documentary in theatre or at a museum. In another example, when sound is spatialized, a user may feel the full effect of a helicopter flying overhead, or the echo of footsteps in a hallway, which may not be possible with legacy audio.

To generate spatial sound, current methods rely on manual processing to adjust, enhance, and modify audio signals, simulating the direction, distance, and movement of sound. This process often includes adjusting volume, balancing left-right speaker output, and fine-tuning acoustic properties to create a realistic sense of space. These adjustments typically require multiple iterations and, in some cases, skilled sound engineers. For example, in film production, experienced sound engineers may spend extensive hours refining acoustic properties through iterative balancing to achieve the final version used in a movie.

Although spatial sound is widely used, current spatialization techniques have several drawbacks. One such drawback is the lack of dynamic environmental awareness. Existing methods often fail to account for changes in the acoustic environment surrounding the sound source. For example, the movement of a sound source, reverberations caused by room geometry, or the presence of obstacles and furniture that affect sound propagation are either ignored or inadequately captured. Incorporating such details manually may require skilled expertise.

Another drawback of current spatialization methods is the level of manual adjustments for calibration required to accurately spatialize the sound. For example, when a location of the sound source changes, or other ambient sounds occur, such as people entering a room, recalibration may be needed to maintain accurate spatial rendering. To do so, current methods require extensive and cumbersome manual adjustments, tweaking and iterating, which can be time-consuming, inconvenient, and inaccurate, thereby, in many instances, resulting in imperfect or less than ideal spatial audio experience.

Yet another drawback is that current techniques are limited real-time systems that lack the control of thorough offline refinement. As such, the current approaches prove to be insufficient for precisely mapping sound sources within intricate 3D environments or for seamlessly adapting to diverse playback setups, such as headphones versus multi-speaker systems, especially when dealing with content where spatial cues are either implicit or absent in the original media.

Additional drawbacks exist when it comes to taking an already existing sound and converting it to spatial audio. In such a scenario, much of the above-mentioned drawbacks of lack of incorporation of surrounding environmental conditions, manual processing, etc. exists. In some instances, when audio has to be produced for movies, TV shows, video games, music, skilled sound engineers manually spending several hours may be required to convert legacy audio, such as from an old movie, into spatialized sound, into the same movie with spatialized sound. One attempt at converting is limited where the systems may only be able to convert spatial audio from one format to another, and not from legacy sound. This method, while useful for compatibility, may not create spatial audio from scratch and merely translates existing spatial metadata.

Another attempt at specialization, such as ambisonics or object-based audio, includes focusing on live or authored content, where spatial data can be added during production, which is also a manual process. However, this approach does not address the growing need to process legacy content or user-generated media, where such data is unavailable. Similarly, machine learning models for audio classification and sound localization often operate in isolation and lack integration with visual data or contextual metadata to provide a holistic spatial understanding. This isolation prevents a full understanding of the audio environment and limits the system's ability to accurately create spatial audio.

Other techniques in spatial audio encoding, such as those leveraging binaural audio or machine learning-based spatial reasoning, e.g., transformer-based models like SPATIAL-AST, may perform some level of sound detection and localization. However, such techniques are not capable of integrating into a cohesive system capable of processing diverse media content offline and in real time, while ensuring compatibility with established spatial audio standards. This remains an unsolved challenge.

As such, there is a need for systems and methods that can automatically generate spatialized audio from existing, non-spatialized (legacy) content by analyzing environmental surroundings and context. Such systems would enhance 3D sound effects and deliver immersive listening experiences without requiring extensive manual input.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The various objects and advantages of the disclosure will be apparent upon consideration of the following detailed description, taken in conjunction with the accompanying drawings, in which like reference characters refer to like parts throughout, and in which:

FIG. 1 is a block diagram of a process for generating spatial audio tracks, in accordance with some embodiments of the disclosure;

FIG. 2 is a block diagram of a system for generating spatial audio tracks, in accordance with some embodiments of the disclosure;

FIG. 3 is a block diagram of a user device used for generating, displaying, and using spatial audio tracks, in accordance with some embodiments of the disclosure;

FIG. 4 is a flowchart of a process for generating spatial audio tracks, in accordance with some embodiments of the disclosure;

FIG. 5 is a flowchart of a process for performing video and audio analysis of a scene/segment of a pre-existing media asset to identify sound sources, in accordance with some embodiments of the disclosure;

FIG. 6 is an example of a scene/segment for which spatialization may be performed to generate spatial audio tracks, in accordance with some embodiments of the disclosure;

FIG. 7 is an example of a JSON structure for a moving car, in accordance with some embodiments of the disclosure;

FIG. 8 is an example of a JSON structure for a moving helicopter, in accordance with some embodiments of the disclosure;

FIG. 9 is an example of a mezzanine file containing the helicopter sound source, in accordance with some embodiments of the disclosure;

FIG. 10 is a sequence diagram of a process for tracking motion trajectories of sound sources and using them to generate spatial audio tracks and related mezzanine files, in accordance with some embodiments of the disclosure;

FIG. 11 is an example of a JSON structure for a sound source that is partially occluded, in accordance with some embodiments of the disclosure;

FIG. 12 is a sequence diagram of a process for generating spatial audio tracks and related mezzanine files for sound sources that have occlusion in their paths, in accordance with some embodiments of the disclosure;

FIG. 13 is an example of a JSON structure for incorporating surrounding environment sounds that affect the acoustics of the sound source for generating spatial audio tracks, in accordance with some embodiments of the disclosure;

FIG. 14 is a sequence diagram of a process for incorporating surrounding environment sounds that affect the acoustics of the sound source for generating spatial audio tracks, in accordance with some embodiments of the disclosure;

FIG. 15 is an example of a JSON structure for integrating sound produced by recurring sound sources into spatial metadata that is to be used to generate spatial audio tracks, in accordance with some embodiments of the disclosure;

FIG. 16 is a sequence diagram of a process for integrating recurring sound sources into spatial metadata that is to be used to generate spatial audio tracks, in accordance with some embodiments of the disclosure;

FIG. 17 is an example of a JSON structure for a video game, in accordance with some embodiments of the disclosure;

FIG. 18 is a sequence diagram of a process for generating spatial audio tracks and related mezzanine files for sound sources in a video game, in accordance with some embodiments of the disclosure;

FIG. 19 is an example of a JSON structure for using factors such as prominence and semantics for determining priority in generating spatial audio tracks and related metadata for sound sources, in accordance with some embodiments of the disclosure;

FIG. 20 is a sequence diagram of a process for using factors such as prominence and semantics for determining priority in generating spatial audio tracks and related metadata for sound sources, in accordance with some embodiments of the disclosure;

FIG. 21 is an example of a JSON structure for determining dialogue intelligibility and making appropriate adjustments when generating spatial audio tracks for sound sources, in accordance with some embodiments of the disclosure;

FIG. 22 is a sequence diagram of a process for determining dialogue intelligibility and making appropriate adjustments when generating spatial audio tracks for sound sources, in accordance with some embodiments of the disclosure;

FIG. 23 is a flowchart of a process for performing post processing for human speech to make its sound quality intelligible, in accordance with some embodiments of the disclosure;

FIG. 24 is an example of a JSON structure for considering peripheral sounds when generating spatial audio tracks for sound sources, in accordance with some embodiments of the disclosure; and

FIG. 25 is a sequence diagram of a process for considering peripheral sounds when generating spatial audio tracks for sound sources, in accordance with some embodiments of the disclosure.

### DETAILED DESCRIPTION

In accordance with some embodiments disclosed herein, some of the above-discussed limitations are overcome by identifying sound sources within a scene of a media asset that exceed a relevance threshold and generating a separate spatial audio track for one or more of the identified sound sources by factoring in their surroundings, such as physical and environmental conditions, and sounds produced by other objects that may affect the acoustics of the sound source for which a spatial audio track is to be generated.

In some embodiments, a scene or segment of a pre-existing media asset may be selected for identifying sound sources within the scene or segment. As referred to herein, a “sound source,” also referred to as “sound-producing object,” or a “sound element,” is an object that produces sound through the vibration of a medium (such as air, water, or solids) or through the interaction of a medium with an object, thereby generating pressure waves that propagate through that medium and result in audible sound. As such, a sound source or sound-producing object may be any object that directly or indirectly produces sound. Some examples of such sound sources range from a ringing bell, a human voice or a barking dog to the sound of wind or rain or audio emitted from a media device or speaker.

The scene or segment may be selected based on one or more criteria, such as relevance of the scene to the context of the media asset, presence of key people or objects in the scene (such as key actors in a movie or an enemy in a video game), the importance of the scene to the plot, etc.

Once the scene is identified, an analysis may be performed to identify sound sources within the scene. The analysis may include video, audio, metadata (e.g., closed captioning, subtitles, etc.), contextual, and/or image analysis. The system may perform any combination of one or more of these types of analyses. With respect to video analysis, the system may use computer vision algorithms to identify visual cues indicating sound-producing objects present within the scene. Likewise, audio analysis may be performed to determine which sounds are detected in the scene. Closed captioning analysis may be performed to determine whether the closed captioning indicates what sounds are produced or provides insight into what sounds are produced within the scene. For example, the closed caption data may include non-speech audio elements, i.e., sounds other than spoken text such as sound effects, etc. Contextual analysis may also be performed to determine the nature and relevance of a sound to a specific scene and to the media asset overall. Identified sound sources may include sounds produced by humans, animals, machines, objects, or any ambient or environmental source, such as the sound of rain or lightning.

In some embodiments, a determination may be made whether to generate a spatial audio track for the sound sources identified in the scene. Since the scene may have several sound sources, a spatial audio track may not be produced for every sound source identified in the scene. As such, spatial audio tracks may be generated for only a subset of the sound sources identified in the scene, or even for a single sound source in certain circumstances.

The system may determine a score for each sound source identified in the scene. The score may be based on one or more factors, including the prominence of the sound source in the scene, relevance of the sound source to the scene and to the overall media asset, and the context of the sound source in relation to overall plot or other elements occurring in the scene. Intelligibility may also be considered, which involves determining whether the sound produced by the sound source can be intelligibly understood. The scoring may also be based on an AI recommendation.

The scoring may be used to determine a) the priority of generating an audio spatial track for the sound source and b) whether to generate an audio spatial track at all for the sound sources, or c) whether to perform only a lower level of processing, such as low fidelity processing, which may involve selecting only certain acoustic elements or surroundings (but not all) and bypassing one or more sound or environmental effects when generating spatial audio track for the sound source. A threshold score may also be predetermined, which may include a range, such as a plurality of levels or tiers. Additionally, different media items (movies, TV series, episodes, documentaries) may have their own threshold scores, or different sounds may have their own threshold scores. If the score computed for a particular sound source exceeds a threshold, a determination may be made that a spatial audio track is to be generated for the sound source. However, if the score computed for a particular sound source does not exceed the threshold, a determination may be made to either a) not generate a spatial audio track for the sound source, or b) generate a lower-fidelity spatial audio track, depending on which tier the score falls within.

The system may also perform an analysis, such as video, audio, closed caption, and/or contextual analysis, to identify both the physical and environmental surroundings of a sound source for which a spatial audio track is to be produced. Physical surroundings may include occlusions, geometry of the space, furniture and objects in the space surrounding the sound source, and other sound sources in close proximity to the sound source for which a spatial audio track is to be created. Environmental surroundings may include rain, wind, lightning, and any other environmental surrounding that produces a sound. The surroundings may also include ambient sounds and any other sound effects such as reverberations, echoes, absorptions, diffusion, and resonance if they have any acoustic effect on the sound produced by the sound source for which a spatial audio track is to be created.

In some embodiments, the system may perform a semantic analysis to determine the contextual relevance of the sound source to the scene, segment, episode, entire season or entire series, movies, video game, etc. The semantic analysis may include assigning semantic weights to the sound sources based on their contextual relevance. The system may use natural language processing (NLP), artificial intelligence (AI), machine learning (ML) and/or the user's prior consumption history to determine the contextual importance of the sound source. In a scenario where two sound sources exist in a scene and a first sound source is assigned a higher semantic weight than a second sound source, the system may prioritize processing, calculations, and generation of spatial metadata and spatial audio track for the first sound source over those for the second sound source. The system may also consider visual and auditory significance, in addition to semantic weights, in determining priority of generating spatial metadata and a spatial audio track or whether to generate a spatial audio track at all when the overall significance is below a threshold. In some instances, such as when the scene is outdoors, based on the semantic weights, the system may bypass reverb calculations, as reverberation generally does not occur in outdoor environments.

In some embodiments, when a sound source is a moving sound source, such as a car or a helicopter, the system may obtain the sound source's current position and its projected position based on its trajectory. When an audio soundtrack is generated for such a moving sound source, the system may incorporate the trajectory to accurately represent the transitory nature of the sound source and the Doppler effect on the sound. The process may include obtaining coordinates of the current position, the trajectory and direction in which the sound source is moving, determination of any occlusion along the trajectory, any other sounds along the trajectory that may impact the acoustics of the sound source, and metadata reflecting all such data may be generated. In some embodiments, a JSON structure that reflects the spatial metadata may be generated and used to generate a mezzanine file having a format that is industry standard-compatible for use by downstream media players.

In some embodiments, the sound source may be a recurring sound source that appears in multiple scenes in a media asset or in multiple episodes in a series. In such a scenario, when the sound source appears in its first instance, the system may generate an ID for the sound source and obtain its attributes. The system may then determine whether the same sound source with the attributes appears in other scenes or episodes. To do so, the system may match the stored attributes of the sound source from its first appearance with attributes of sound sources that appear subsequently in the same media asset or in other episodes or media assets. If a match is determined, then a determination may be made that it is the same sound source that has reappeared in a later scene or in a later episode. For such a recurring sound source, rather than performing processing from scratch to generate spatial data and then using it to generate a spatial audio track, the system may reuse the originally created spatial data for the sound source and adjust and modify the spatial data based on the new scene or environment in which the sound source reappears.

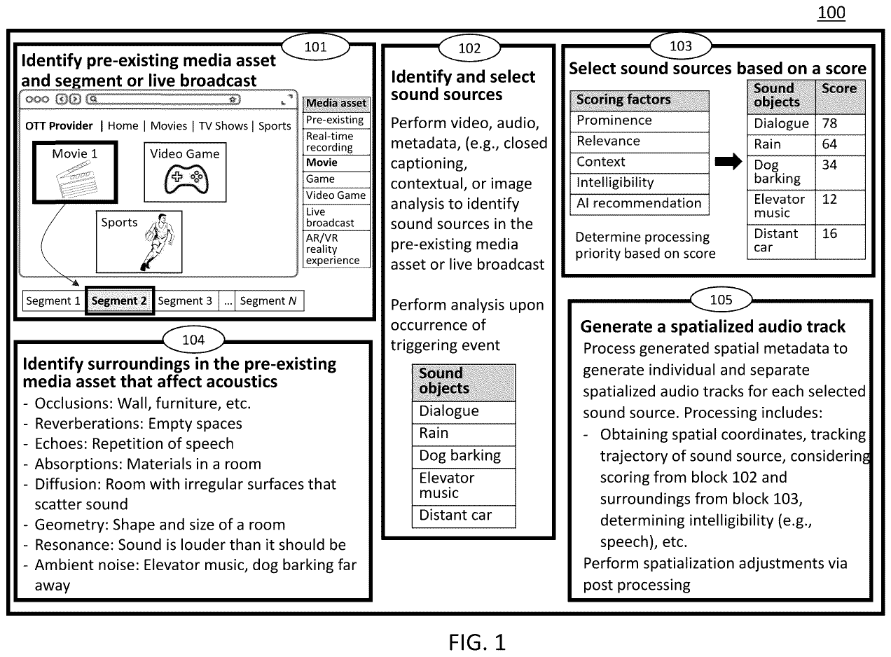

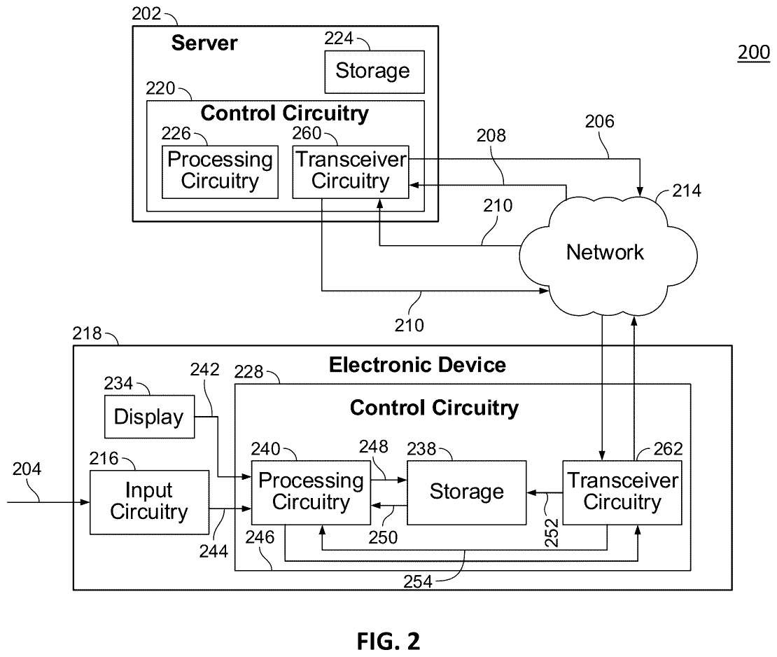

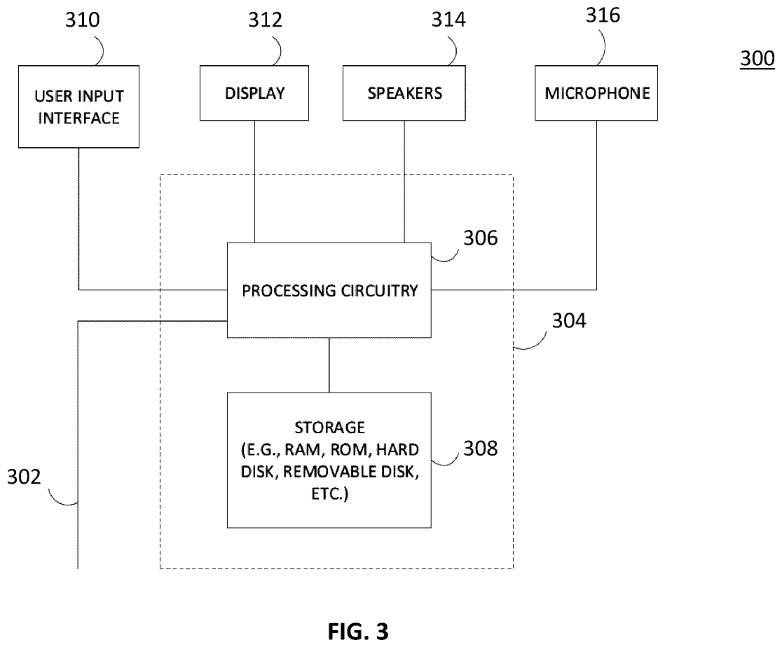

Turning now to the figures, FIG. 1 is a block diagram of a process 100 for generating spatial audio tracks, in accordance with some embodiments of the disclosure. The process 100 may be implemented, in whole or in part, by systems or devices such as those shown in FIGS. 2 and 3. One or more actions of the process 100 may be incorporated into or combined with one or more actions of any other process or embodiments described herein. The process 100 may be saved to a memory or storage (e.g., any one of those depicted in FIGS. 2 and 3) as one or more instructions or routines that may be executed by a corresponding device or system to implement the process 100.

In some embodiments, the process 100 may be used for processing a pre-existing media asset, such as a movie, video game, television content, documentary, music, or animations, to generate spatial audio tracks and metadata compliant with formats such as Dolby Atmos, MPEG-H Audio, or DTS:X. The process may be used for both offline and real-time workflows. In offline mode, the process may be used to refine metadata and spatial audio iteratively to achieve high fidelity, while in real-time mode, the process may be used to optimize algorithms and leverage hardware acceleration to enable efficient processing of live content with minimal latency.

As used herein, a “spatial audio track” refers to a data structure comprising audio content and associated spatial metadata that defines how the audio should be rendered in three-dimensional space. The metadata may include parameters such as position, trajectory, object size, orientation, gain, and acoustic attributes such as reverberation, occlusion, and Doppler effects. A spatial audio track may represent an individual sound object or a group of sound objects and may be compliant with object-based audio formats such as Dolby Atmos, MPEG-H Audio, or DTS:X. As referred to herein, a “sound object” is a processed audio entity that combines a discrete audio representation or signal, such as a mono audio file (e.g., . wav file), with associated spatial metadata. This metadata encapsulates a sound source's position, trajectory, and other relevant spatial attributes within a defined 3D space. Once processed, the sound source becomes a sound object, an addressable entity in the 3D environment, enabling manipulation of its spatial characteristics during playback. For instance, a bird's song, when combined with GPS coordinates and flight path data, transforms into or becomes a sound object that can be rendered to realistically position the bird's movement and position in space. In this context, GPS and flight path data provide real-world spatial coordinates and motion information that can be translated into metadata for 3D audio rendering. While raw GPS data may not be used directly by a playback system, it can be processed to generate positional metadata-such as the sound source's speed, direction of movement, and position over time. This metadata enables the rendering engine to simulate the motion of the sound source (e.g., a flying bird) within a virtual 3D space. By mapping real-world movement into the audio domain, the system can reproduce a realistic auditory experience that aligns with the visual or contextual narrative of the media asset. In this example, the sound object is the mono audio file (e.g., . wav of the bird's song) and metadata describing the bird's position, trajectory, and other spatial properties. The metadata informs the playback system (e.g., a client device) how to render it and how the sound behaves in the 3D environment.

In some embodiments, the spatial audio tracks are automatically generated using the embodiments described herein, and via process 100. This may significantly elevate the listening experience by positioning sound sources within a three-dimensional space and providing a more immersive and realistic environment for the listener. The spatial audio tracks automatically generated through process 100 may also allow listeners to accurately pinpoint the location of sounds, enhancing engagement and the sense of presence. The process 100 may create spatial audio tracks and associated metadata from existing media, enabling the transformation of standard audio into a spatially aware format. The process may also be used for automated post-processing of sound sources to ensure clear speech intelligibility. Process 100 may be used in any type of media and applications, such as video games, virtual reality content, and media assets such as movies, TV series, documentaries, etc. Once spatial soundtracks generated using the described methods are available, they may be utilized by listener devices that support spatial audio to deliver the audio in full 3D, thereby enhancing the listening experience.

At block 101, the process 100, in some embodiments, may include identifying the pre-existing media asset and a scene or segment of the identified media asset for generating spatial audio tracks. The identified media, as described above, may be a movie, game, television content, TV broadcast, documentary, music file or video, animation, or some other form of media asset. In some embodiments, it may be a pre-existing media asset, and in other embodiments (not shown), the media asset may be a live broadcast or live preview of a scene, and specialization may be performed in real time to generate audio tracks during the live video taping of content.

In some embodiments, the pre-existing media asset may be part of an OTT library of offerings, such as a Netflix offering. In other embodiments, the pre-exiting media asset may be an application, such as a gaming application, an AR/VR experience, or any other form of interactive application that presents audio and visual displays.

At block 101, once the media asset is identified, a segment of the media asset, or a scene, may be identified for processing to generate spatial audio tracks. In some embodiments, a trigger-based process may be used for identifying a segment and/or a scene within the media asset for generating spatial audio tracks. Since a media asset, such as a movie, video game, or AR/VR experience, may be lengthy, the trigger-based approach may be used to avoid the resource-intensive task of generating spatial audio for every segment/scene of the media asset.

In some embodiments, the trigger condition may be user-defined, and in other embodiments, the control circuitry, such as the control circuitry 220 and/or 228 of system depicted in FIG. 2, may automatically define a trigger condition, such as based on a recommendation from a machine learning (ML) or artificial intelligence (AI) engine. In yet other embodiments, the control circuitry 220 and/or 228 may automatically define a trigger condition and provide it to the user for approval.

The trigger condition, in some embodiments, may be used for identifying key moments worthy of spatial audio enhancement. Such key moments may be determined by the control circuitry 220 and/or 228 based on metadata associated with the media asset or by performing a video or audio analysis. The trigger may be based on events, significant sounds, or visual cues, indicating a level of importance for which spatial processing may be performed to generate spatial audio. For example, in a sports-related media asset, a score, such as a touchdown in a football game, may trigger spatial audio generation, or in a video game, an approaching enemy detected through frame analysis may be deemed relevant and exceeding a relevancy or importance threshold to initiate the spatialization process. Referring to the touchdown example in a football game, a user may be consuming legacy audio for the football game which may not include spatial audio. In this scenario, since the touchdown is an important part of the game, either upon a user's request, or automatically without user input, the system may go back in the timeline before the touchdown and automatically generate a spatial track for the touchdown such that when the user replays the touchdown, they may be able to consume it with spatial audio. Although such backtracking has been described in a sports context, the embodiments are not so limited, and the system may automatically backtrack and generate spatial audio for any sound produced by a sound source if the sound source is deemed relevant to the scene or segment such that when the scene or segment is replayed, it can be experienced with spatial audio.

As such, creation of spatial audio may be performed only for certain relevant and impactful moments and scenes that exceed the relevancy, context, and/or importance threshold, thereby conserving computational power, memory and resources by not performing it for every scene in the media asset.

At block 102, the control circuitry 220 and/or 228 may identify and select sound sources for which spatial audio tracks may be generated. To identify the sound sources, the control circuitry 220 and/or 228 may undergo one or more of audio, video, contextual, or image analysis of the identified scene or segment in the media asset. The control circuitry 220 and/or 228 may also analyze metadata of the scene or segment, which may be by analyzing closed captioning data, to identify the sound sources in the identified scene or segment. In this embodiment, the control circuitry 220 and/or 228 processes pre-existing media assets identified in block 101, such as a movie, video game, sports game, TV, or AR/VR experience. The media assets are processed to generate spatial audio tracks and metadata compliant with industry standards, such as Dolby Atmos, MPEG-H Audio, or DTS:X. The control circuitry 220 and/or 228 integrates multiple modalities, including various types of analysis described above, such as video frame analysis, audio signal processing, and contextual metadata parsing, to identify, classify, and localize sound-producing elements, also referred to as sound sources, within a scene or segment. The control circuitry 220 and/or 228 can do so by using both offline workflows, which allow iterative refinement of spatial metadata, and real-time configurations for live content processing.

Video analysis provides more than mere observation; it deciphers the narrative embedded within a video's frames. It involves interpreting actions, interactions, and their implied consequences, such as recognizing a person walking across a room and inferring potential noise based on the floor type, e.g., more noise if it's an old hardwood floor versus a carpeted room. In another scenario, if in a scene a door is slammed, even though there may or may not be any audio from the scene, analyzing video may allow determination that some noise would occur due to this slamming of the door. As such, video analysis performed by the control circuitry 220 and/or 228 automatically may provide a deeper understanding of the scene, the context of the scene or segment, and the story unfolding within the frames. Such contextual understanding and related data obtained based on video analysis may allow the control circuitry 220 and/or 228 to determine what sound sources are present and what type of sound is produced by them.

To perform such video analysis, the control circuitry 220 and/or 228 may use any of several methods. In one embodiment, the control circuitry 220 and/or 228, may use AI models, such as Mask R-CNN and EfficientDet, to identify sound sources. As referred to herein, sound sources are objects in the media asset, such as in a particular scene of segment, that produce a sound. These objects may be anything physical, like a TV, music player, to an animal, such as a dog barking, to environmental, such as rain, wind, lightening, people talking, sound of steps across a room, sound of a car driving by, sound of a wooden floor creaking, or any other sound produced in the scene or segment. For example, ambient sounds and environmental audio effects, such as rain, wind, or fire may be identified and integrated, into spatial audio tracks to enhance immersion and realism. The process of integrating them may include synthesizing or modifying ambient audio elements based on visual cues from the scene and the spatial context derived from metadata.

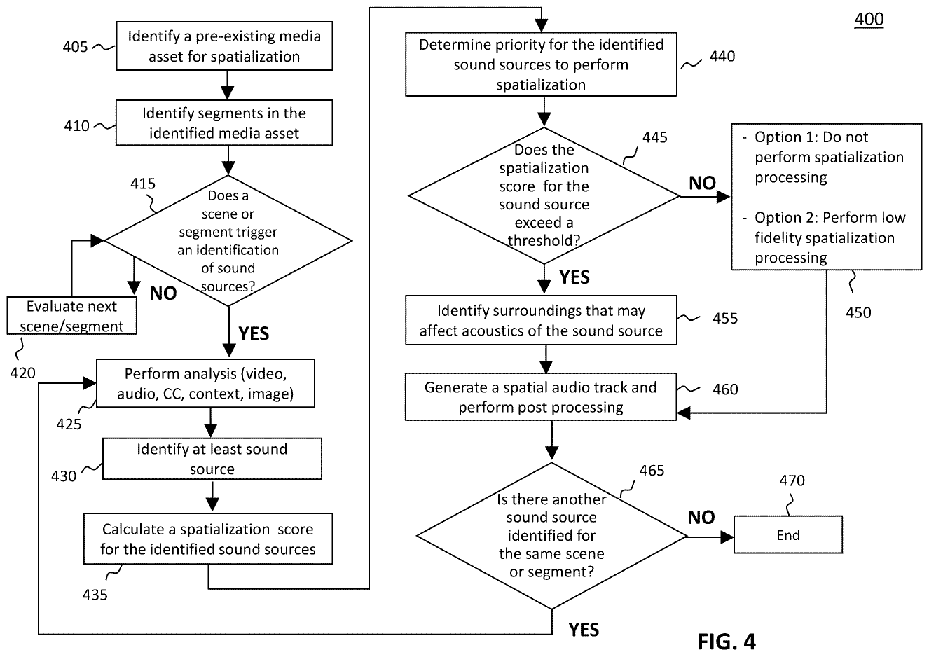

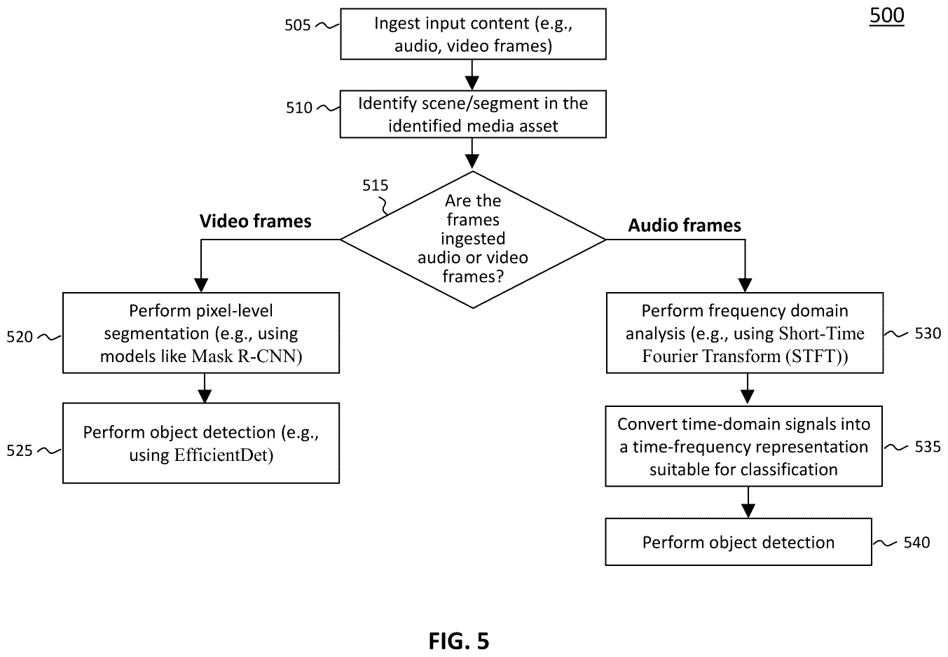

The video analysis performed may detect the sound source and enable tracking of the sound source across video frames, determining its spatial location and movement. The control circuitry 220 and/or 228, based on video analysis, may also reconstruct a 3D scene using depth estimation, creating a mesh of the environment. The control circuitry 220 and/or 228 may also use all the video analysis data to enhance spatial accuracy and determine the relationship between objects and their surroundings for analysis of sound produced by the sound source based on its surroundings. Additional details relating to video analysis and the processes used are described in relation to FIGS. 4 and 5 below.

When the control circuitry 220 and/or 228 performs audio analysis, it may not only determine the sound sources within the scene or segment that produce the sound, but also identify various characteristics of sound within a space, such as a room in the scene of the media asset where the sound is occurring. The control circuitry 220 and/or 228 may also differentiate between sounds that are near and far or loud and soft, and separate primary sound sources from ambient noise, like elevator music. For example, the control circuitry 220 and/or 228 may separate an important dialogue in a scene in the media asset from a faraway noise of wind blowing or a car passing by and may also determine the effects of such ambient noise on, for example, dialogue in a scene. The control circuitry 220 and/or 228 may also identify overlapping sounds, such as simultaneous dialogue and dog barking or car passing by, and such audio data may be used to generate distinct audio tracks for each. The control circuitry 220 and/or 228 may also identify sounds such as music, evaluating its relevance and either isolating it or acknowledging its influence on primary sounds, such as the dialogue in the scene, and may prioritize one over another based on its contextual relevance to the scene/segment. The control circuitry 220 and/or 228 may use a number of approaches when performing audio analysis. For example, the control circuitry 220 and/or 228 may use techniques like short-time Fourier transform (STFT) to convert audio into a time-frequency representation, enabling machine learning models, such as SoundNet, to identify sound sources and classify sound events into categories like dialogue, footsteps, or environmental effects, thus providing a deeper understanding of the audio in the scene to tell the whole story. It may also identify sound sources through features like volume and frequency. Additional details relating to audio analysis and the processes used are described in relation to FIGS. 4 and 5 below.

When the control circuitry 220 and/or 228 performs closed caption analysis, it may use the results of such analysis to identify sound sources within the scene/segment of the media asset. It may perform the closed caption analysis in real time while a movie is playing and closed caption is displayed, or it may obtain a closed caption manifest file (e.g., a WebVTT file or a text file that contains information about the timing and content of subtitles or closed captions, allowing them to be synchronized with video content) and pre-process it to perform the analysis. By performing closed caption analysis, the control circuitry 220 and/or 228 may significantly enhance detection of sound sources in the scene/segment since closed captions may provide a more detailed narrative than the audio or visual components alone, describing actions and sounds that might be visually or aurally ambiguous. To perform the analysis, the control circuitry 220 and/or 228 may parse closed captions using natural language processing models like BERT to extract semantic information about sound events, even when audio cues are subtle or not present. For example, a caption that states a non-speech element such as “door slam” may allow the control circuitry 220 and/or 228 to determine that a sound source, which is the door slamming, is present in the scene/segment, even when it is not readily apparent in the audio. The control circuitry 220 and/or 228 may also link the closed caption with visual motion of a closing door in the scene to confirm the sound source.

In some embodiments, the control circuitry 220 and/or 228 may perform a contextual analysis, identifying sound sources and their relevance based on the context. Such contextual analysis may be performed by the control circuitry 220 and/or 228 by analyzing video, audio, and metadata across single or multiple frames to determine the context and the narrative of the scene. For example, whether a sound is relevant may be determined by analyzing multiple frames that provide contextual cues to listen for that sound, such as in a scene in a movie where, several frames before a sound occurs, a character asks, “Did you hear any loud boom?” and several frames later another character recalls hearing it. Based on this context, the sound becomes relevant to the scene, even if that is not immediately apparent. Such contextual data may allow determining the relevance of sounds, distinguishing between critical events like a gunshot during a murder scene and background noise, such as a windchimes during a garden-party scene. By obtaining contextual data, the control circuitry 220 and/or 228 may identify sound sources and their significance, linking contextual descriptions, like the “door slam” caption with visual motion, to enhance spatial understanding.

The process of contextual understanding may involve the control circuitry 220 and/or 228 determining semantic similarity by analyzing the scene's context. The control circuitry 220 and/or 228 may use AI to infer the contextual relevance of objects and understand how actions influence sound and sound sources in the scene.

Although a few types of analysis are described to identify sound sources and their relevance, the embodiments are not so limited, and other types of analysis may also be performed. For example, in another embodiment, the control circuitry 220 and/or 228 may perform a recurring patterns analysis, such as identifying a repeating sound source or a recurring type of sound, e.g., as may occur during a car chase sequence. To do so, the control circuitry 220 and/or 228 may analyze both video and audio across the media asset and detect patterns. For example, the control circuitry 220 and/or 228 may generate an ID or a notation for a scene that has a rapid object motion, a high density of sounds, or frequent camera cuts as indicative of action, like a car chase or another action scene. It may then save the attributes of such scenes, and when another scene in the media asset has matching attributes, the control circuitry 220 and/or 228 may detect the pattern and identify the repeated sound sources. In one embodiment, the detection of a new scene may be determined by identifying a frame as an I-frame or an IDR-frame.

Returning to FIG. 1, at block 103, once the analysis is performed and sound sources in a scene or segment are identified, the control circuitry 220 and/or 228 may calculate a score for the identified sound source and select sound sources based on their score for generating spatial audio tracks. The control circuitry 220 and/or 228 may also prioritize which sound sources are to take priority in the generation of spatial audio tracks over others based on their scores. The control circuitry 220 and/or 228 may also determine whether the sound source is relevant to the context or whether the sound source exceeds a relevance threshold for a spatial soundtrack to be generated based on the score.

In some embodiments, the score calculated at block 103 may be based wholly or partially on the prominence of a sound source. The control circuitry 220 and/or 228 may calculate acoustic attributes for each object based on its weighted prominence. Prominence may include auditory prominence and visual prominence. In some embodiments, auditory prominence may be derived from existing audio features, such as volume or spectral density. For instance, if the scene or segment includes loud engine noises, the system may deprioritize calculating acoustic attributes for subtle environmental sounds such as wind.

Visual prominence may be calculated by using object detection models, such as Mask R-CNN. Using such models, control circuitry 220 and/or 228 may determine the visual prominence of each sound source by measuring its screen space coverage. For example, a large explosion covering 20% of the screen would have a higher visual weight than a leaf rustling in a corner, which may be 1% or less than 1% of screen coverage. These visual weights may be normalized across the scene to prioritize the calculation of acoustic attributes for more prominent objects.

Prominence may also be calculated based on depth perception. For example, if a first person speaking is in the foreground of the screen while a second person is shown much farther away, thereby decreasing their visual prominence, the distance or depth of the second person may be weighted lower than the first person's.

In some embodiments, the score calculated at block 103 may be based wholly or partially on the relevance or context of a sound source. The control circuitry 220 and/or 228 may calculate acoustic attributes for each sound source based on its weighted relevance.

In some embodiments, the control circuitry 220 and/or 228 may use relevance as a key factor to prioritize and optimize spatial audio processing such that computational resources are intelligently allocated, in priority of the relevance of the identified sound sources to the context of the scene or segment in the media asset.

The control circuitry 220 and/or 228 may use the relevance score calculated to assign or determine a degree of importance of the sound source to the scene or segment. The score may also be used by the control circuitry 220 and/or 228 to prioritize spatial processing to ensure that more significant sound sources receive higher-fidelity processing than lower-relevance sound sources. In some embodiments, the scoring may be used by the control circuitry 220 and/or 228 to guide the order in which nearly equally relevant sound sources are processed.

In some embodiments, the control circuitry 220 and/or 228, such as by guidance from the user, AI or ML engines, or based on context of the overall media asset, may set a relevance threshold. If a sound source falls below the threshold, then it may receive minimal, partial, or no spatial audio processing. By using such threshold, the control circuitry 220 and/or 228 may use computational resources only on sound sources that contribute most significantly to the overall plot or context of the scene or segment. Since relevance may change from scene to scene or even frame to frame, the score relating to relevance may also change dynamically from scene or even frame to frame.

In some embodiments, the control circuitry 220 and/or 228 may determine semantic weights using natural language processing (NLP) and sound classification models to infer the contextual relevance of objects. For example, the control circuitry 220 and/or 228 may bypass reverb calculations in outdoor environments, as reverberation is less relevant in open spaces than in closed spaces, such as a room. Such contextual awareness may be used by the control circuitry 220 and/or 228 to dynamically determine acoustic attributes, so that it may prioritize calculations for objects with higher visual, auditory, and semantic significance.

Some examples of such contextual awareness to determine relevance includes event-based metadata generation, such as detecting a scoring event where a touchdown is about to happen or just happened, whether in live sports or or in a movie scene, or identifying approaching enemies in video games such as “Call of Duty,” allowing for real-time adjustments to spatial processing. The control circuitry 220 and/or 228 may also differentiate between full and low-fidelity spatial processing based on relevance, background, and repetition, ensuring that critical audio cues are rendered with high fidelity while background or repetitive elements receive lower fidelity or fewer positional adjustments.

In some embodiments, the score calculated at block 103 may be based wholly or partially on the intelligibility of a sound source. The control circuitry 220 and/or 228 may calculate acoustic attributes for each sound source based on its weighted intelligibility. In some embodiments, intelligibility may be related to the ability to clearly understand spoken words. Since scenes change dynamically in a media asset; likewise, intelligibility may also change dynamically, and the control circuitry 220 and/or 228 may calculate a score for a sound source based on intelligibility and adjust it on a scene-by-scene basis.

In some embodiments, when ambient noise or overlapping sounds obscure dialogue, such as when loud music is playing, multiple people are speaking simultaneously, or environmental sounds interfere, the control circuitry 220 and/or 228 may determine which acoustic elements to minimize, remove, or enhance in order to improve speech clarity and overall intelligibility. Intelligibility may be tied to relevance and contextual awareness, as certain sounds, particularly human speech, may be relevant in certain circumstances and not as relevant in others. In some embodiments, non-speech sounds may also be evaluated for their intelligibility. For example, a gunshot in a murder/suspense movie type media asset may be relevant, and its intelligibility may be determined by the control circuitry 220 and/or 228.

In some embodiments, to maintain dialogue intelligibility, the control circuitry 220 and/or 228 may dynamically adjust environmental audio effects based on real-time transcription accuracy. This may involve the control circuitry 220 and/or 228 using speech-to-text analysis on combined audio tracks to evaluate dialogue intelligibility. In this embodiment, if the control circuitry 220 and/or 228 determines that the transcription accuracy falls below a predefined threshold, the control circuitry 220 and/or 228 may perform adjustments such as limiting the volume or number of environmental effects and enhancing the volume of the dialogue. This process of separating dialogue from other audio components may involve using source separation models, like Open-Unmix, and then analyzing the dialogue track with NLP models to generate a real-time transcription. Simultaneously, the combined audio track, including environmental effects, may be transcribed by the control circuitry 220 and/or 228 and intelligibility may be reassessed to determine if further processing is needed until the dialogue become intelligible. In some embodiments, even after a threshold number of attempts, if the control circuitry 220 and/or 228 determines that the dialogue, or any other sound source, is still intelligible, then a low score may be given, and that sound source may not be processed for spatial processing.

In some embodiments, the control circuitry 220 and/or 228 may compare the intelligibility scores between the dialogue-only and combined transcriptions. If the combined transcription's intelligibility score deviates significantly from the dialogue-only's score, indicating interference from environmental effects, the control circuitry 220 and/or 228 may attenuate or remove competing audio effects. For example, in a scene with dialogue overlaid by rain and thunder, if the transcription accuracy drops significantly when the environmental sounds are included, the control circuitry 220 and/or 228 may automatically reduce the volume of the rain and thunder to restore the intelligibility of the dialogue. Considering the factors described above, which include context of the sound source, the control circuitry 220 and/or 228 may calculate an overall intelligibility score of the sound source, which may allow it to determine whether to process it at all for spatial processing or to prioritize other sound sources having a higher intelligibility score.

In some embodiments, the score calculated at block 103 may be based wholly or partially on an AI recommendation for the sound source. In these embodiments, based on the data used for training of the AI model, the AI model may use some combination of the factors described above, or use other factors. The control circuitry 220 and/or 228 may use the recommendations to then generate an overall score for the sound sources.

The control circuitry 220 and/or 228 may also combine any of the factors, such as prominence, relevance, context, intelligibility, etc., in any manner to generate the overall score for the sound source. All the generated scores may be indexed in a table and may change dynamically from scene to scene. The control circuitry 220 and/or 228 may also generate a graph that displays the changes in any one factor, or the overall score, for a sound source across various frames, scenes, and segments.

Although a few factors for determining a score have been described, the embodiments are not so limited. For example, in some embodiments, a user's preferences that they have stored in their profile may also be used in calculating the scores. For instance, the user's profile may indicate that the user likes horror movies or action movies, which may mean that the user likes, in particular, the horror or action elements of the movies, such as screams, scary music, car chases, or fight scenes. Accordingly, the control circuitry 220 and/or 228 may access the user's profile or viewing history and use that to determine whether spatial audio processing is to be performed. As such, the control circuitry 220 and/or 228 may leverage machine learning models and analyze user consumption habits to identify user preferences. For example, if a user frequently watches horror movies and demonstrates an enjoyment of specific sound effects like screams, the control circuitry 220 and/or 228 may give such sound sources a higher score. Accordingly, when a similar sound appears in a new scene, the control circuitry 220 and/or 228 may automatically assign it a higher score since it falls within the user's preferences, e.g., screams in a horror movie may be given a higher score, which may indicate their importance and priority for generating spatial audio. On the other hand, if the control circuitry 220 and/or 228 detects that a user fast-forwards through scenes containing gunshots or violence, it may use such data of the user's viewing history to calculate a lower score for such sound elements, and as such, the control circuitry 220 and/or 228 may not perform any spatial processing or may perform a lower level of spatial processing for such sound sources.

At block 104, in some embodiments, the control circuitry 220 and/or 228 may analyze various environmental factors to accurately render spatial audio, considering how these factors influence the acoustics of sound sources. Some of these factors considered by the control circuitry 220 and/or 228 may include occlusion, reverberation, echoes, absorption, diffusion, geometry, resonance, and ambient noise, and other sounds and effects that may contribute to the sound produced by the sound source and how the sound may be attenuated based on the surroundings, other sounds, and environmental effects.

With respect to occlusions, which are physical obstructions on sound propagation, such as a wall in between a person speaking within a scene of the media asset and another person listening, the control circuitry 220 and/or 228 may determine the extent and degree of the occlusion and its effect on the sound produced by the sound source. The control circuitry 220 and/or 228 may use various techniques to model such occlusions, such as generating simulations and models that incorporate the physical obstructions, and then testing sounds within the model to determine the type of effect they may have on the sound source. For example, the control circuitry 220 and/or 228 may generate a 3D model of the wall and then propagate sound within a virtual atmosphere to determine how the sound signals are received across the wall, to then use the model in determining how the occlusion may affect the sound in the media asset. The control circuitry 220 and/or 228 may also add material properties to the simulated 3D model of the wall. The control circuitry 220 and/or 228 may also obtain depth information through techniques like monocular depth estimation or stereo disparity, to generate a mesh representing potential occluding surfaces.

In some embodiments, the control circuitry 220 and/or 228 may also track occlusion that may occur along the path of a moving sound source. For example, if a person in the media asset is walking toward a room while speaking, then the control circuitry 220 and/or 228 may predict that the user, based on the current path, is likely to enter the room. If so, a wall may occlude their speech either from another person sitting in the room or from the microphone of the camera's point of view capturing the scene. Accordingly, for each moving sound source, the control circuitry 220 and/or 228 may use techniques, such as ray tracing techniques, to calculate potential occlusion paths by casting rays from the listener's position to the sound source. The control circuitry 220 and/or 228 may also generate scene meshes to determine the extent of occlusion. The control circuitry 220 and/or 228 may also apply diffraction, absorption, and other factors to generate occlusion-related metadata and calculate overall sound attenuation for the occlusion such that the spatial audio track that is generated accurately represents how the sound would be affected by the occlusion. The occlusion-related metadata generated may include parameters such as occlusion coefficient, reflection intensity, and diffraction characteristics. The metadata may then be integrated into the spatial audio metadata and used to accurately represent the sound from the sound source based on the occlusion. For example, when a speaker moves behind a wall or a car is driven past a building, the control circuitry 220 and/or 228 may adjust the sound properties to reflect the occlusion along the path. Similarly, in a scene where a person moves from an open room into a hallway partially blocked by a door, ray tracing may be used by the control circuitry 220 and/or 228 to determine the proportion of sound rays blocked, diffracted, or reflected, resulting in dynamic adjustments that accurately represent the transition into the occluded space.

The control circuitry 220 and/or 228 may also account for reverberation when factoring in the surroundings for generating spatial audio data for a sound source. Reverberation, as is well known, occurs when sound waves persist in an enclosed space after the original sound source has stopped. This phenomenon is particularly noticeable in empty spaces with hard surfaces that reflect sound waves well. In an empty room, for example, speech may not cease abruptly; instead, the sound waves may bounce off the walls, ceiling, and floor, creating a series of decaying reflections that prolong the speech. This lingering effect, known as reverberation, may add a sense of spaciousness and depth to the audio. In this context, with respect to a scene or segment in the media asset, the control circuitry 220 and/or 228 may determine that, based on the type of enclosed space, reverberations are likely to occur. As such, the control circuitry 220 and/or 228 creates virtual reverberation models and tests sound signals to determine the effects they would have in the scene in the media asset.

The control circuitry 220 and/or 228 may also account for echo when factoring in the surroundings for generating spatial audio data for a sound source. Echoes, as is well known, are repetitions of a sound. The control circuitry 220 and/or 228 may identify echoes as discrete sound events that repeat with decreasing volume. For example, if a scene in the media asset depicts large, open spaces with reflective surfaces, such as a canyon or tunnel, then the control circuitry 220 and/or 228 may account for the effect of potential echo on the sound source and accordingly generate spatial metadata and a spatial audio track based on that analysis.

The control circuitry 220 and/or 228 may also account for absorption and absorbing materials when factoring in the surroundings for generating spatial audio data for a sound source. Absorption, as is well known, is the reduction of sound wave energy when certain absorbing materials are present in the location where the sound source is producing the sound. For example, a room with thick carpets, heavy curtains, and upholstered furniture may be more absorbent of sound waves and would thus result in a less reverberant and quieter environment than an empty room or a room with less furniture or fewer absorbent objects. A classic example to illustrate the point may be an anechoic chamber, designed to eliminate echoes and reverberation, where sound may barely travel. Based on the scene in the media asset, e.g., type of room, chamber or hall, and materials and objects in that space, the control circuitry 220 and/or 228 may automatically conduct an analysis to determine the effects of absorption on the sound source and then accordingly generate spatial metadata and a spatial audio track based on the analysis.

The control circuitry 220 and/or 228 may also account for diffusion when factoring in the surroundings for generating spatial audio data for a sound source. Diffusion, as is well known, may occur when sound waves are scattered by irregular surfaces. For example, a room with textured walls, bookshelves, or other uneven surfaces may diffuse sound waves and prevent them from concentrating in specific areas thereby creating a sound-scattering effect. Based on the scene in the media asset, if the control circuitry 220 and/or 228 determines it includes textured walls, bookshelves, or other uneven surfaces, then control circuitry 220 and/or 228 may automatically conduct an analysis to determine the effects of diffusion on the sound object and then accordingly generate spatial metadata and a spatial audio track based on the analysis.

The control circuitry 220 and/or 228 may also account for geometry when factoring in the surroundings for generating spatial audio data for a sound source. In some embodiments, the geometry of a room or other space in the media asset, including its shape and size, may contribute to how sound properties of the sound from the sound source may be affected. For example, while a circular room may provide increased sound intensity in certain areas, an uneven or oddly shaped room may cause sound waves to travel unevenly or not reach a particular corner of the room. According, the control circuitry 220 and/or 228 may automatically analyze the shape of the space to determine the effects of its geometry on the sound source and then accordingly generate spatial metadata and a spatial audio track based on the analysis.

The control circuitry 220 and/or 228 may also account for resonance when factoring in the surroundings to generate spatial audio data for a sound source. Resonance, as is well known, may occur when an object vibrates at its natural frequency, thereby amplifying the sound. This may cause certain frequencies to become louder than others, making the sound seem louder than it actually is. For example, a glass may resonate when a specific musical note is played, causing it to vibrate and produce a louder sound than would otherwise be expected. The control circuitry 220 and/or 228 may automatically analyze resonance to determine its effects on the sound source, and accordingly generate spatial metadata and a spatial audio track based on the analysis.

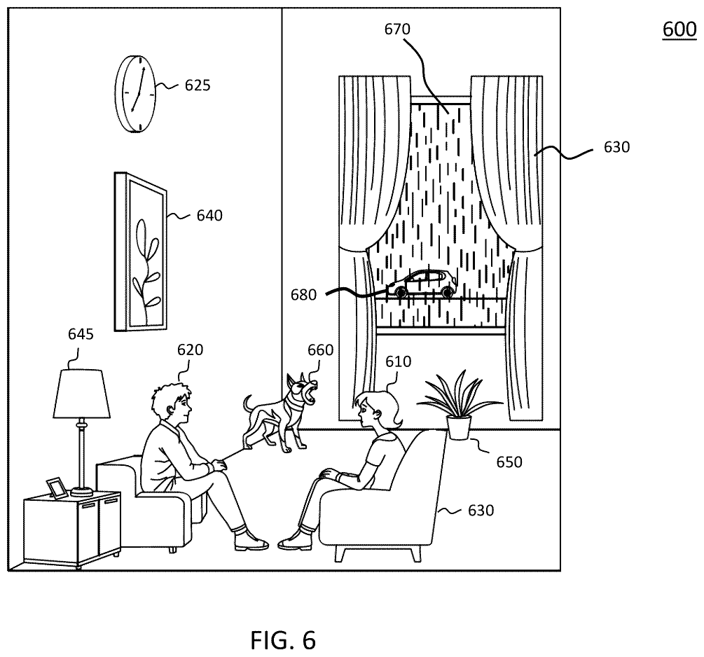

The control circuitry 220 and/or 228 may also account for ambient noise when factoring in the surroundings to generate spatial audio data for a sound source. Ambient noise may be any noise that is not the primary sound, such as distant traffic, a dog barking as in FIG. 6, background music, or environmental sounds. The control circuitry 220 and/or 228 may automatically analyze ambient noise levels and characteristics to determine their impact on the sound produced from the sound sources, and accordingly generate spatial metadata and a spatial audio track based on the analysis.

Although a few factors for identifying surroundings and their effect on the sound quality of the sound sources have been described, the embodiments are not so limited, and any other sounds produced or surrounding environment, or environmental conditions that contribute to the sound may also be analyzed automatically and considered by the control circuitry to generate metadata that can be used in generating spatial audio for the sound source that accurately represents how the sound from the sound source may propagate based on its surroundings.

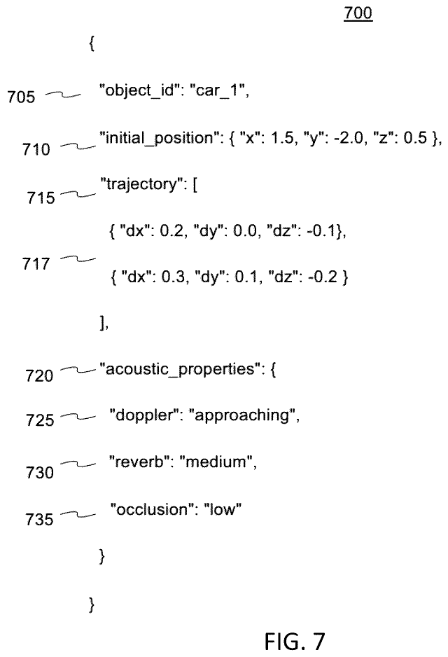

At block 105, in some embodiments, the control circuitry 220 and/or 228 generates spatialized audio tracks for each of the sound sources from block 103 that exceed a threshold score. Generation of the audio tracks may be based on spatial data generated by the control circuitry 220 and/or 228. Generation of the spatial data may be based on the analysis, scoring, and considerations of surroundings performed through blocks 103 and 104. Such spatial metadata may describe the properties of each sound source, or at least those sound sources whose score exceeds a predetermined score. These properties may include the sound source's initial position, trajectory, and acoustic attributes such as Doppler effects, reverberation, occlusion, echoes, diffusion, etc. These properties may be encoded to ensure precise spatial playback. For example, a moving car's sound may be encoded with trajectory vectors and attenuation parameters to ensure precise spatial playback. The metadata may be formatted in machine-readable structures, such as JSON or XML, as depicted in FIG. 7. The spatial metadata may also describe other factors relating to the sound source, such as its prominence in the media asset, contextual relevance, intelligibility, acoustic properties, etc.

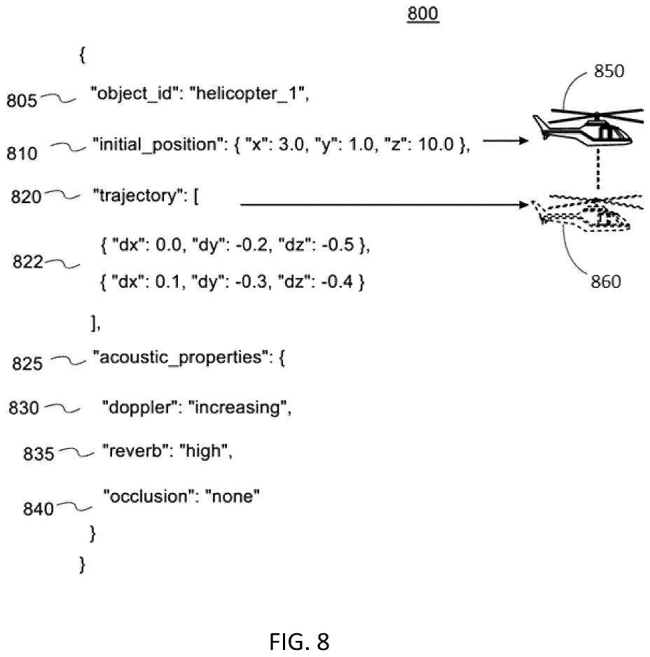

When a sound source is in motion, such as the car or a helicopter, the spatial metadata generated by the control circuitry 220 and/or 228 based on the analysis, scoring, and considerations of surrounding performed through blocks 103 and 104 may include a movement vector and Doppler shift data. For example, a scene in the media asset may display a helicopter moving from the background to the foreground while its blades are rotating. The control circuitry 220 and/or 228 may automatically detect the helicopter's visual trajectory using object tracking models and identify its rotor sounds through spectral analysis. The control circuitry 220 and/or 228 may then synchronize the audiovisual elements related to the sound of the rotors and generate spatial metadata describing the helicopter's movement vector, Doppler shift, rotational audio properties, sound effects, and surrounding environmental factors, such as the influence of other sounds, occlusions, echoes, and additional effects and parameters derived through the analysis performed at blocks 103 and 104. An example of a JSON illustrating several elements of such metadata for the helicopter is shown in FIG. 8.

The spatial metadata generated, as described earlier, also incorporates any occlusions encountered by the sound sources. By incorporating the occlusions, the control circuitry 220 and/or 228 enhances spatial audio realism. It does so by incorporating dynamic occlusion modeling by analyzing the 3D spatial relationships between sound sources, listeners, and the environment. The process used by the control circuitry 220 and/or 228 involves reconstructing a 3D scene from video frames using depth information extracted via monocular depth estimation or stereo disparity. The control circuitry 220 and/or 228 then generates a mesh representing potential occluding surfaces and dynamically calculates sound attenuation, echo, absorption, reverberations, reflection, and diffusion caused by these occlusions. The control circuitry 220 and/or 228 then generates spatial metadata by integrating all occlusion-related analysis and calculations, including parameters like occlusion coefficients, reflection intensity, and diffraction parameters.

The spatial metadata generated, as described earlier, also incorporates any visual cues, such as those obtained based on a video analysis of the scene or segments of the media asset. In some embodiments, the control circuitry 220 and/or 228 may generate spatial metadata for environmental audio by analyzing visual cues. For example, if in a scene of the video a rainstorm is visible, based on the video analysis of the scene, the control circuitry 220 and/or 228 may use the lightning or water falling as visual cues. The control circuitry 220 and/or 228 may then use these visual cues to generate sounds, like rain, lightning and wind to enhance existing audio to match the visual scene. The control circuitry 220 and/or 228 may also, based on visual cues, such as a moving sound source, assign positions and trajectories to sounds. It may also account for diffusion and reverberation to simulate realistic sound interactions with the environment. All such data may then be incorporated to generate spatial data that is reflective of the visual cues.

In some embodiments, spatial data may incorporate changes in the environment, such as camera zooms, pans, or scene transitions. By incorporating such changes, the control circuitry 220 and/or 228 may ensure that spatial positioning and volume of audio sources are reflected in the spatial metadata. The control circuitry 220 and/or 228 may then leverage real-time scene analysis to adjust the audio mix dynamically. For example, if an explosion occurs off-frame but shifts into view due to a camera pan, the control circuitry 220 and/or 228 may gradually increase its volume and adjust its position in the audio field to reflect its on-screen trajectory. By doing so, the control circuitry 220 and/or 228 may ensure seamless synchronization between visual and auditory elements. Although the embodiments described incorporate a few types of data into the generated spatial data, e.g., obtaining spatial coordinates, tracking trajectories of moving sound sources, considering scoring from block 102 and surroundings from block 103, determining intelligibility (e.g., speech), incorporating visual cues and occlusions, etc., the embodiments are not so limited, and any other sound effects, surroundings, and other considerations that may affect the sound produced by the sound sources may also be incorporated into the generated spatial data.

Once spatial data is generated, it is used by the control circuitry 220 and/or 228 to generate audio tracks for the sound sources identified in the scene or segment for which a decision was made that spatial audio tracks are to be generated. In other words, in some embodiments, if the sound sources exceed a threshold score, as described in block 103, which may be based on prominence, relevance, context, intelligibility, and/or an AI recommendation, then separate and individual such audio tracks for each such sound source may be generated.

In some embodiments, the process of generating the spatial data, generating an audio track from the generated spatial data, prioritizing which sound source is to take priority in generation of the audio track, optimizing processing of spatial data for specific scenarios, and postprocessing the generated audio tracks may performed automatically and in real time by the control circuitry 220 and/or 228 of the electronic device that stored the spatial data, a server, or a cloud server, without any user intervention. For example, in one embodiment, in the process of generating an audio track for a sound source, the control circuitry 220 and/or 228 may optimize the processing of spatial audio for specific types of scenes in movies, such as action scenes, by reducing computational complexity and enabling metadata reuse across episodes in a series or similar scenes in a single movie. By performing such optimizations, the control circuitry 220 and/or 228 may minimize redundant calculations while maintaining high-quality spatial audio playback. To identify such action scenes, or other types of scenes, the control circuitry 220 and/or 228 may analyze video and audio patterns that match predefined criteria. The control circuitry 220 and/or 228 may also perform the types of analysis described in block 102. Based on the analysis, the control circuitry 220 and/or 228 may flag and classify scenes with rapid object motion, high sound density, or frequent camera cuts as action scenes. Using this classification, the control circuitry 220 and/or 228 may apply optimized processing techniques that reduce the amount of computation and processing needed for generating spatial audio metadata. In one embodiment, to reduce the amount of computation and processing needed for generating spatial audio metadata, with respect to an action scene, where computational demands are typically higher, the control circuitry 220 and/or 228 may prioritize processing of primary sound sources (e.g., explosions, car engines) and de-emphasize secondary or ambient sounds. For instance, the control circuitry 220 and/or 228 may spatialize explosions and vehicle movements with full metadata, while background crowd noise is represented as a diffuse sound with reduced spatial metadata. Such a selective processing approach may allow the control circuitry 220 and/or 228 to reduce processing load, conserve hardware and computational resources and improve processing efficiently, without significantly impacting audio fidelity.

In some embodiments, where spatialized audio tracks are to be generated for recurring objects, the control circuitry 220 and/or 228 reuse spatial metadata from an earlier occurrence of the same sound source in the media asset. For example, for episodic content, such as TV series or content that is a prequel or a sequel, such as “Star Wars” movies, the control circuitry 220 and/or 228 may reuse metadata generated for recurring objects across episodes or similar scenes. For example, if a starfighter or the Millenium Falcon, from the Star Wars series, appears in multiple episodes or prequels and sequels of a series and maintains consistent visual and auditory characteristics, the control circuitry 220 and/or 228 may generate an object ID for the starfighter or the Millenium Falcon, match the object ID using a persistent identifier, and reuse its spatial metadata when the helicopter appears in other scenes within the same episode, across different episodes, or even in related media assets. For example, when an object is matched, i.e., the same helicopter (or in the example above, starfighter or the Millenium Falcon) appears in both previous and a new scene or episode, the control circuitry 220 and/or 228 may retrieve its previously generated metadata and adapt it to the new scene. For instance, if the helicopter appears at a different angle or altitude in a new scene or episode, only the position and trajectory parameters may be adjusted, while acoustic properties such as Doppler effects and reverberation may be retained, thereby preventing the control circuitry 220 and/or 228 from having to perform all the analysis and calculations from scratch and saving computational resources. Object matching, as described above, such as for the helicopter, may be performed by the control circuitry 220 and/or 228 by analyzing key visual and acoustic features, such as color, shape, motion patterns, and spectral properties of the sound.

The process of generating spatial audio tracks may include obtaining spatial coordinates of the sound source, using audio plug-ins, mixing and panning acoustic elements within a 3D space while factoring in the spatial coordinates and manipulating height and depth to create a realistic audio environment, to generate the spatial audio track.

It may also involve encoding the generated spatial audio tracks and associated metadata into a mezzanine format. To do so, the control circuitry 220 and/or 228 may consolidate the audio, video, and metadata components into a unified file structure. The control circuitry 220 and/or 228 may also use a format that adheres to established standards, such as Dolby Atmos or MPEG-H Audio, to ensure compatibility with downstream systems. Each sound source may be isolated and processed by the control circuitry 220 and/or 228 into its own spatial audio track. The generated audio track for the sound source may be tagged with its corresponding metadata, including position, trajectory, and acoustic properties. The control circuitry 220 and/or 228 may also embed the metadata as an auxiliary data stream, either stored separately or multiplexed within the container alongside the audio data. The control circuitry may then package these components into a single container, such as an MP4 file with MPEG-H streams or an ADM BWF file for Dolby Atmos. All spatial metadata described above, such as environmental audio metadata, occlusion metadata, trajectory metadata, reverberation metadata, and/or spatial data generated based on analysis performed at blocks 103 and 104, may be encoded into the mezzanine format alongside other sound sources.

Performing such encoding may ensure that playback systems can dynamically adapt these ambient effects based on the listener's environment.

The process may also include binaural processing for converting the spatial audio tracks for headphone playback, utilizing head-related transfer functions (HRTFs) to simulate natural ear perception.

The process of generating and editing the generated spatial audio tracks may also include rendering and playback, where a spatial audio rendering engine may be used by the control circuitry 220 and/or 228 to decode the data and adapt it to the specific playback system, such as a media device, a speaker system, headphones (e.g., wireless in-ear headphones), smartphones, or another type of listening devices.

Once the spatial audio track is generated, the control circuitry 220 and/or 228 may automatically perform post processing to ensure that spatial mix translates accurately in different listening environments. For example, to do so, the control circuitry 220 and/or 228 may continuously monitor the user's listening environment and perform any adjustments to the generated spatial audio tracks as needed to provide the optimal listening experience for their environment. As such, the process may also involve ensuring format compatibility with listening devices and platforms.

In some embodiments, post processing may also include the control circuitry 220 and/or 228 providing user controls to adjust the intensity of spatial effects, such as distance perception, ambient noise levels, and reverb. A user interface may be displayed by the control circuitry 220 and/or 228 to the user on the user device to access and make adjustments using the controls. The adjustment of controls may allow the users/listeners to customize their experience based on their preferences or environmental conditions. For example, a user may amplify dialogue while reducing ambient effects for clarity or increase reverb to simulate a concert hall environment.

FIG. 2 is a block diagram of a system for generating spatial audio tracks, in accordance with some embodiments of the disclosure and FIG. 3 is a block diagram of a user device used for generating, displaying, and using spatial audio tracks, in accordance with some embodiments of the disclosure. FIGS. 2 and 3 also describe example devices, systems, servers, and related hardware that may be used to implement processes, execute user interface operations, and all other steps, functions and functionalities described at least in relation to FIG. 1, and 4-16. Further, FIGS. 2 and 3 may also be used for identifying scene or segment of a media asset, a level of a video game, an episode of a series, a portion of a virtual reality experience or which a spatial audio track is to be created. For the identified scene or segment, FIGS. 2 and 3 may also be used for performing analysis that may include any one of video, audio, closed caption, and/or semantic or contextual analysis to identify one or more sound sources within the scene, calculating a score for the identified sound sources, where the score may be dependent on the prominence, relevance, context, intelligibility of the sound source, performing analysis to identify both physical and environmental surroundings and sounds that may affect the acoustics of the sound source, where such physical environments may include the geometry of the space and surrounding objects, such as furniture, and where the environmental surroundings may include environmental sounds such as rain, wind, lightning, thunder, and also incorporating all sound effects such as reverberations, echoes, absorptions, diffusion, and resonance, and use all such data to generate spatial metadata that incorporates both the priority, importance of the sound source and its relevance, and the surrounding physical and environmental conditions that may affect the acoustics of the sound source. FIGS. 2 and 3 may also be used for sound source that are recurring sound source or for modifying spatial data and adjusting surrounding sounds for those sound sources whose sound become unintelligible due to the surrounding physical and/or environmental sounds, utilizing AI and ML to execute describe embodiments, and performing functions related to all other processes and features described herein.

In some embodiments, one or more parts of, or the entirety of system 200, may be configured as a system implementing various features, processes, code, functionalities and components of FIG. 1, and 3-25. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., list of sound sources, subset of sound sources for which spatial audio tracks are to be generated, scores associated with sound sources, sound source processing priority, results of video, audio, closed caption, semantic, and contextual analysis, identification of physical and environmental surroundings including associated sounds, spatial coordinates of each sound source, spatial metadata generated for each sound source and associated JSON structures, mezzanine files, and, AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to list of sound sources, subset of sound sources for which spatial audio tracks are to be generated, scores associated with sound sources, sound source processing priority, results of video, audio, closed caption, semantic, and contextual analysis, identification of physical and environmental surroundings including associated sounds, spatial coordinates of each sound source, spatial metadata generated for each sound source and associated JSON structures, mezzanine files, and, AI and ML algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to identifying a sound source for which spatial audio track is to be generated, the control circuitry 228 may determine its surrounding physical and environments sounds that affect the acoustics of the sound source such that spatial metadata that accurately reflects the sound produced by the sound source based on its surroundings can be generated and then used to generate a spatial audio track. The control circuitry 228 may also perform steps of processes described in FIGS. 1, 4-5, 10, 12, 14, 16, 18, 20, 22, and 25, including determining whether a sound source is a recurring sound source or whether the audio track generated for the sound source is intelligible.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays, such as a display of a spatial audio track that can be selected and played. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as data relating to sound sources, list of sound sources, subset of sound sources for which spatial audio tracks are to be generated, scores associated with sound sources, sound source processing priority, results of video, audio, closed caption, semantic, and contextual analysis, identification of physical and environmental surroundings including associated sounds, spatial coordinates of each sound source, spatial metadata generated for each sound source and associated JSON structures, mezzanine files, and, AI and ML algorithms, and input from primary devices and secondary devices. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably identifying sound sources and performing analysis and calculation for generating a spatial audio track for the sound source. Control circuitry 220 and/or 218 may be based on any suitable processing circuitry such as processing circuitry 226 and/or 240, respectively. As referred to herein, “processing circuitry” should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 220 and/or control circuitry 218 is configured for identifying scene or segment of a media asset, a level of a video game, an episode of a series, a portion of a virtual reality experience or which a spatial audio track is to be created. For the identified scene or segment, the control circuitry 220 and/or control circuitry 218 may also be used for performing analysis that may include any one of video, audio, closed caption, and/or semantic or contextual analysis to identify one or more sound sources within the scene, calculating a score for the identified sound sources, where the score may be dependent on the prominence, relevance, context, intelligibility of the sound source, performing analysis to identify both physical and environmental surroundings and sounds that may affect the acoustics of the sound source, where such physical environments may include the geometry of the space and surrounding objects, such as furniture, and where the environmental surroundings may include environmental sounds such as rain, wind, lightning, thunder, and also incorporating all sound effects such as reverberations, echoes, absorptions, diffusion, and resonance, and use all such data to generate spatial metadata that incorporates both the priority, importance of the sound source and its relevance, and the surrounding physical and environmental conditions that may affect the acoustics of the sound source. The control circuitry 220 and/or control circuitry 218 may also be used for sound source that are recurring sound source or for modifying spatial data and adjusting surrounding sounds for those sound sources whose sound become unintelligible due to the surrounding physical and/or environmental sounds, utilizing AI and ML to execute describe embodiments, and performing functions related to all other processes and features described herein.

Computing device 218 receives a user input 204 at input circuitry 216. For example, computing device 218 may receive sound control data from a user interface when a user is requesting to enhance or minimize acoustics for a spatial audio track.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, 5G sidelink (5G NRV2X), 6G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, Wi-Fi, WiMAX, GSM, UTMS, CDMA, TDMA, 3G, 4G, 4G LTE, or other wireless transmission protocols.

Processing circuitry 240 may receive input 204 from input circuitry 216. Processing circuitry 240 may convert or translate the received user input 204 that may be in the form of voice input into a microphone. In some embodiments, input circuitry 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4-5, 10, 12, 14, 16, 18, 20, 22, and 25, respectively.

FIG. 3 is a block diagram of a user device used for generating, displaying, and using spatial audio tracks, in accordance with some embodiments of the disclosure. In an embodiment, the equipment device 300, is the same equipment device 202 of FIG. 2. The equipment device 300 may receive content and data via input/output (I/O) path 302. The I/O path 302 may provide audio. The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306 In client/server-based embodiments, the control circuitry 304 may include communications circuitry suitable for receiving and transmitting list of sound sources, subset of sound sources for which spatial audio tracks are to be generated, scores associated with sound sources, sound source processing priority, results of video, audio, closed caption, semantic, and contextual analysis, identification of physical and environmental surroundings including associated sounds, spatial coordinates of each sound source, spatial metadata generated for each sound source and associated JSON structures, mezzanine files. Communications circuitry may also be used for identifying scene or segment of a media asset, a level of a video game, an episode of a series, a portion of a virtual reality experience or which a spatial audio track is to be created. For the identified scene or segment, communications circuitry may also be used for performing analysis that may include any one of video, audio, closed caption, and/or semantic or contextual analysis to identify one or more sound sources within the scene, calculating a score for the identified sound sources, where the score may be dependent on the prominence, relevance, context, intelligibility of the sound source, performing analysis to identify both physical and environmental surroundings and sounds that may affect the acoustics of the sound source, where such physical environments may include the geometry of the space and surrounding objects, such as furniture, and where the environmental surroundings may include environmental sounds such as rain, wind, lightning, thunder, and also incorporating all sound effects such as reverberations, echoes, absorptions, diffusion, and resonance, and use all such data to generate spatial metadata that incorporates both the priority, importance of the sound source and its relevance, and the surrounding physical and environmental conditions that may affect the acoustics of the sound source. Communications circuitry may also be used for sound source that are recurring sound source or for modifying spatial data and adjusting surrounding sounds for those sound sources whose sound become unintelligible due to the surrounding physical and/or environmental sounds, utilizing AI and ML to execute describe embodiments, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., list of sound sources, subset of sound sources for which spatial audio tracks are to be generated, scores associated with sound sources, sound source processing priority, results of video, audio, closed caption, semantic, and contextual analysis, identification of physical and environmental surroundings including associated sounds, spatial coordinates of each sound source, spatial metadata generated for each sound source and associated JSON structures, mezzanine files, and, AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display.

In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to identifying sound sources within a scene, generating spatial audio metadata for the identified sound sources, and using the spatial metadata to generate a spatial audio track, and performing all the functionalities discussed associated with the figures mentioned in this application.

FIG. 4 is a flowchart of a process 400 for generating spatial audio tracks, in accordance with some embodiments of the disclosure. The process 400 may be implemented, in whole or in part, by systems or devices such as those shown in FIGS. 2 and 3. One or more actions of the process 400 may be incorporated into or combined with one or more actions of any other process or embodiments described herein. The process 400 may be saved to a memory or storage (e.g., any one of those depicted in FIGS. 2 and 3) as one or more instructions or routines that may be executed by a corresponding device or system to implement the process 400.

At block 405, in some embodiments, the control circuitry 220 and/or 228 may include identifying the pre-existing media asset and a scene or segment of the identified media asset for generating spatial audio tracks. The identified media, as described above, may be a movie, game, television content, movie sequels or prequels, episode in a series, documentary, music, animation, or some other form of media asset. In some embodiments, it may be a pre-existing media asset and in other embodiments, the media asset may be recorded live, and specialization may be performed in real time while the live video recording is taking place, such as by buffering some frame and generating spatialized audio for the buffered frames, while the video recording is in progress.

At block 410, the control circuitry 220 and/or 228 may identify segments in the identified media asset for which spatial audio tracks are to be generated. Although segments or scenes are described and may be used in certain embodiments, the control circuitry 220 and/or 228 may also select a specific scene, a specific portion of an episode of a series, a certain level of a video game, a certain experience in a virtual reality game, or any other frames, scenes, segments of a plurality of media types for generating the spatial audio tracks.

At block 415, for the selected segment, a determination may be made whether the identified a scene or segment trigger an identification of a sound source. As such the segment's relevance, importance, and context may be determined to then determine whether the segment meets a threshold to trigger to perform the processing and analysis for identifying sound sources within the segment. To determine whether the segment meets the threshold trigger, e.g., has key moments of relevance, importance, and context, the control circuitry 220 and/or 228 may perform a video, audio, closed caption, or contextual analysis. These key moments, based on events, sounds, closed captions, context, or visual cues may include a touchdown in football game, a six in a crickets game, a key scene in a movie, or an approaching enemy in a video game. When such segment meets or exceeds the threshold, it may then serve as a trigger for the control circuitry 220 and/or 228 to initiate spatial processing. Such a trigger condition may be user-defined and in other embodiments, the control circuitry, such as control circuitry 220 and/or 228 of system depicted in FIG. 2, may automatically define a trigger condition, such as based on a recommendation from a machine learning (ML) or artificial intelligence (AI) engine. By selecting scenes and actions of relevance, the control circuitry 220 and/or 228 may conserve computational resources by focusing spatial audio generation for important and relevant events that exceed a threshold, rather than processing every frame, scene, or segment.

If a determination made at block 415 that the scene or segment does not trigger an identification of sound sources, then the process may continue to block 420 where the next scene or segment may be analyzed, and a determination may again be made whether the next scene or segment includes content that may rise to the level of the trigger. The control circuitry 220 and/or 228 may continue to move from one segment to the next until a segment is identified that triggers the justification of identifying sound sources and performing spatial processing for that segment.

If a determination is made at block 415 that an identified scene or segment does trigger an identification of the sound sources, then the control circuitry 220 and/or 228 may perform one or more of a plurality of analysis at block 425 which include video, audio, closed caption, context, and or image analysis as described earlier in block 102 of FIG. 1 to identify a plurality of sound sources. In some embodiments, only a single sound source may be identified in the scene or segment and in other embodiments multiple sound sources may be identified in the same scene or segment. For example, multiple sound sources, such as the two individuals 610 and 620 having a dialogue, the dog 660 barking, the rain 670 falling, and the car 680 passing by outside a house in FIG. 6 may be the multiple sound sources identified. To identify the sound source, the control circuitry 220 and/or 228 may integrate the results of such analysis (e.g., any one or more results of audio, video, context, image, etc.) and use the results to identify the sound sources at block 430. By integrating video and audio analysis, metadata extraction, and spatial reasoning, the control circuitry 220 and/or 228 may generate spatial audio tracks dynamically from existing content. The control circuitry 220 and/or 228 may incorporate spatial reasoning capabilities to enhance dynamic scene understanding. For instance, the control circuitry 220 and/or 228 may infer whether one sound source is closer to the listener than another or determine relative positions of multiple sources.

At block 430, the control circuitry 220 and/or 228, if a plurality of sound sources are identified, at least one sound source may be selected based on priority determination at blocks 435 and 440 for generating spatial audio tracks. in the selected scene or segment.

At block 435, the control circuitry may calculate a spatialization score for the identified sound sources. The score may guide the determination of which sound sources are to be selected for generating spatial audio tracks, and which are not, and which sound sources are to take priority in the generation of spatial audio tracks over others. Such scoring may be based on the sound source's relevance, importance, prominence, context, in the scene or segment and/or overall, to the media asset. When a portion of the score may also be based on the prominence of a sound source, the control circuitry 220 and/or 228 may calculate acoustic attributes for the sound source based on its weighted prominence. A portion of the score may also be based on the visual prominence of a sound source, which may be calculated by using object detection models, such as Mask R-CNN. The control circuitry 220 and/or 228 may also normalize prominence weights across the scene to prioritize the calculation of acoustic attributes for more prominent objects. A portion of the score may also be based on the relevance or context of a sound source. As such, the control circuitry 220 and/or 228 may calculate acoustic attributes for each sound source based on its weighted relevance. The control circuitry 220 and/or 228 may generate semantic weights using natural language processing (NLP) and sound classification models, to infer the contextual relevance of objects. A portion of the score may also be based on the intelligibility of the sound source. As such, the control circuitry 220 and/or 228 may calculate am intelligibility score for the sound source.

With respect to priority and gauging importance of sound sources, in some embodiments, the control circuitry 220 and/or 228 may perform a video analysis (or any of the other types of analysis described in block 102 of FIG. 1) to identify key people or objects that are relevant and important to the scene, segment, or the media asset overall, such as the main hero, and ensure that spatial audio tracks are generated for sound produced by them since. Accordingly, such key people or objects are treated as sound sources that are given priority over other sound source in generating spatial audio. The control circuitry 220 and/or 228 may object tag such key people and objects and use the tagging to ensure they are given priority. For instance, if a scene includes a main character playing pinball in an arcade, the control circuitry 220 and/or 228 may tags the character's pinball machine as a primary object and other machines as secondary. Audio generation may then be focused on the primary object, suppressing ambient noise from the secondary machines.

Once the score has been calculated for the sound sources, at block 440, in one embodiment, the control circuitry may determine priority of the identified sound sources to perform spatialization and generate a spatial audio track. As described earlier, one sound source may take priority over another sound source in performing spatialization and generation of spatial audio track. Such priority may depend on the score calculated, which may depend on each sound source's relevance, prominence, importance, and contextual relationship to the scene, segment, or the media asset overall.

At block 445, the control circuitry 220 and/or 228 may determine whether the spatialization score for the sound source exceeds a threshold. If a determination is made at block 445 that the spatialization score for the sound source does not exceed a threshold, then the control circuitry 220 and/or 228 may either use option 1 or option 2 as a next step in the process. In some embodiments, option 1 may include not performing spatialization process on the sound source that does not exceed a threshold. In other words, an audio spatial track may not be generated for that sound source likely because the sound source may either not be relevant, prominent, important, or contextually relevant to the scene or segment, or its relevance, prominence, context may fall below the threshold for the control circuitry 220 and/or 228 to utilize resources for generating audio tracks for such sound sources. A second option that may also be available by the control circuitry 220 and/or 228 is to perform a low fidelity specialization for that sound source. Low fidelity processing may involve selecting only certain acoustic or surroundings, but not all, and bypassing one or more sound or environmental effects on the sound source, in processing the sound source that falls below a threshold. For example, the control circuitry 220 and/or 228 may bypass reverb calculations for the sound source.

If a determination is made at block 445 that the sound source does exceed the threshold, then the process may move to block 455 where the control circuitry may identify surroundings (such as environmental factors) that may affect acoustics of the sound source.

These surroundings, which are also referred to above as surrounding or environmental factors, may include occlusions, reverberations, echoes, absorptions, diffusions, geometry, resonance, and ambient noise, environment, environmental sounds, and other sounds and effects that may contribute to the sound produced by the sound source and how the sound may be attenuated based on the surroundings, other sounds, and environmental effects.

With respect to occlusions, the control circuitry 220 and/or 228 may determine the extent and degree of the occlusion and its effect on the sound produced by the sound source. To do so, the control circuitry 220 and/or 228 may use various techniques to model such occlusions, such as by generating simulations and models that include the physical obstructions, and then test sounds within the model to determine the type of affect it may have on the sound source. The control circuitry 220 and/or 228 may also track occlusion that may be incurred along a path of a moving sound source. The control circuitry 220 and/or 228 may also apply diffraction, absorption, and other factors to generate occlusion-related metadata and calculate overall sound attenuation for the occlusion. The occlusion-related metadata generated may include parameters such as occlusion coefficient, reflection intensity, and diffraction parameters.

With respect to reverberation, the control circuitry 220 and/or 228 may determine that, based on the type of enclosed space, reverberations are likely to occur. As such, the control circuitry 220 and/or 228 may automatically generate virtual reverberation models and test sound signals to determine how they would affect the scene in the media asset.

With respect to echoes, the control circuitry 220 and/or 228 may consider the effect of a possible echo on the sound source based on the surroundings, such as geometry of a room, or a large outdoor space like a canyon depicted in the scene or segment, and then accordingly generate spatial metadata and spatial audio track based on the consideration.

With respect to absorption and absorbing materials, which may be present based on the materials in a room, such a room with thick carpets, heavy curtains, and upholstered furniture, when such are present in a scene, the control circuitry 220 and/or 228 may automatically conduct an analysis to determine the effects of absorption on the sound source and then accordingly generate spatial metadata and spatial audio track based on the consideration.

With respect to diffusion, which occur when sound waves are scattered by irregular surfaces, when such surfaces are present in the scene or segment, the control circuitry 220 and/or 228 may automatically conduct an analysis to determine the effects of diffusion on the sound source and then accordingly generate spatial metadata and spatial audio track based on the consideration.

With respect to geometry, e.g., the geometry of a room or other space in the scene or segment, the control circuitry 220 and/or 228 may automatically analyze the shape of the space to determine the effects of its geometry on the sound source and then accordingly generate spatial metadata and spatial audio track based on the consideration.

With respect to resonance, which may occur in a scene or segment, such as when an empty wine glass is tapped with a fork, the control circuitry 220 and/or 228 may automatically analyze for resonance to determine the effects on the sound source and then accordingly generate spatial metadata and spatial audio track based on the consideration

With respect to ambient noise, which may be present in the scene or segment, such distant traffic, dog barking, control circuitry 220 and/or 228 may automatically analyze ambient noise levels and characteristics to determine their impact on the sound produced from the sound sources.

Although a few factors for identifying surroundings and their effect on the sound quality of the sound sources have been described, the embodiments are not so limited and any other sounds produced or surrounding environment, or environment that conditions that contribute to the sound may also be analyzed automatically and considered by the control circuitry to generate spatial metadata that can be used in generating spatial audio for the sound source that accurately represents how the sound from the sound source may propagate based on its surroundings.

At block 460, in some embodiments, the control circuitry 220 and/or 228 may generate a spatial audio track for the sound sources that exceed the threshold at block 445 by factoring in the identified surroundings from block 455. In another embodiment, when option 2 is selected by the control circuitry 220 and/or 228 at block 450, i.e., to perform low fidelity processing, the control circuitry 220 and/or 228 may generate spatial audio track for those sound sources that fall below the threshold with only considering selecting only certain acoustic or surroundings, but not all, and bypassing one or more sound or environmental effects on the sound source, in processing the sound source. In yet another embodiment, there may be lower limit, or tiers of limits, below the threshold and if the score for the sound source falls below the lower limit of the threshold, or within a certain lower tier below the threshold, then a spatial audio track for such sound sources may not be created.

Referring to block 460, generation of the spatial audio tracks for the sound sources may be based on spatial data generated by the control circuitry 220 and/or 228, which is generated based on the analysis, scoring, and considerations of surrounding through blocks as described in blocks 435 and 445 in FIG. 4 and blocks 103 and 104 in FIG. 1.

Such spatial metadata for the sound sources, i.e. sound sources that are selected for generating spatial audio tracks, may incorporate the sound source's initial position, trajectory, and acoustic attributes such as doppler effects, reverberations, occlusions, echoes, diffusion, resonance. The spatial metadata may also incorporate the geometry of the space in which the sound source is displayed in the scene or segment, such as a room shown in the scene or segment and its geometry. When a sound source is in motion, the spatial metadata may incorporate data relating to its movement vector and doppler shift data. When integrating occlusion visible in a scene or segment into the spatial metadata, the control circuitry 220 and/or 228 may integrate all occlusion-related analysis and calculations, including parameters like occlusion coefficients, reflection intensity, and diffraction parameters. When visual cues are incorporated into the spatial metadata, the control circuitry 220 and/or 228 may perform a video analysis of the scene or segments and based on the visual cues in the scene or segment the generate spatial metadata. For example, based on visual cues, the control circuitry 220 and/or 228 generate sounds, like rain, lightning, wind and enhance existing audio to match the visual scene if it's raining in the scene or assign positions and trajectories and also account for diffusion and reverberation when the sound source, such as a helicopter, is moving in the scene. Spatial data may also incorporate changes in the environment, such as camera zooms, pans, or scene transitions. It may also include spatial coordinates of the sound source and projected coordinates based on its trajectory. In some embodiments, spatial data may incorporate any and all audio properties, sound effects, surroundings, and any other sounds that may affect the acoustic properties of the sound source. In other embodiments, spatial data may incorporate sound effects, surroundings, and other sounds that may affect the acoustic properties of the sound source as long as the sound effects, surroundings, and other sounds are contextually relevant, prominent, and/or intelligible and not incorporate each and every sound to limit the amount of processing. Spatial metadata may then be represented in form of a JSON file, such as JSON files depicted in FIGS. 7-9, 11, 13, 15, 17, 19, 21, and 24.

The process of generating the spatial audio track using the spatial metadata may include the control circuitry 220 and/or 228 using audio plug-ins, mixing and panning acoustic elements within a 3D space while factoring in the spatial coordinates, manipulating height and depth to create a realistic audio environment, encoding audio frames, and performing other generation steps to generate the spatial audio track. The process may also involve the control circuitry 220 and/or 228 encoding the generated spatial audio tracks and associated metadata into a mezzanine format by consolidating the audio, video, and metadata components into a unified file structure that is formatted to standards, such as Dolby Atmos or MPEG-H Audio.

In some embodiments, post processing may be performed on the generated spatial audio track for the sound source by the control circuitry 220 and/or 228. Such post processing may be in real-time and automatically performed by the control circuitry 220 and/or 228 based on triggering factors. In some embodiments, the triggering factor may be the intelligibility of the spatial audio track. In some embodiments, the control circuitry 220 and/or 228 may automatically analyze the spatial audio track once generated for its intelligibility using various tools and techniques. If the control circuitry 220 and/or 228 determines that the generated audio spatial track is intelligible, then the control circuitry 220 and/or 228 may attenuate or removes competing audio effects that may cause the intelligibility. For example, in a scene with dialogue overlaid with rain and thunder, if the transcription accuracy drops significantly when the environmental sounds are included, the control circuitry 220 and/or 228 may determine that the rain and thunder are causing the intelligibility and as such automatically reduce the volume of the rain and thunder to restore intelligibility of the dialogue.

Post processing may also be performed by the control circuitry 220 and/or 228 for other reasons. In one embodiment, post processing may be performed to ensure compatibility with downstream systems, involving isolation of audio objects, tagging sound sources with metadata (position, trajectory, acoustic properties), and embedding metadata as an auxiliary data stream within containers like MP4 or ADM files.

Post processing may also be performed to provide optimal listening experience based on monitoring the listener's environment. For example, binaural processing may be performed using HRTFs for listening devices, such as headphones and other playback systems.

Post-processing may also be performed based on input received via user control, which may be provided to the user on a user interface. If the user provides changes in acoustics or sound effects using the controls, the control circuitry 220 and/or 228 may adjust spatial effects like distance perception and reverb, allowing for personalized customization of the audio experience.

At block 465, the control circuitry 220 and/or 228 may repeat the process 445-460 for any other sound elements that were identified in the scene based on a priority of spatial processing determined at block 440. Once spatial audio tracks are generated for all the identified sound source for which spatial audio tracks are to be generated, then the process may end at block 470.

FIG. 5 is a flowchart of a process 500 for performing video and audio analysis of a scene/segment of a pre-existing media asset to identify sound sources, in accordance with some embodiments of the disclosure. The process 500 may be implemented, in whole or in part, by systems or devices such as those shown in FIGS. 2 and 3. One or more actions of the process 500 may be incorporated into or combined with one or more actions of any other process or embodiments described herein. The process 500 may be saved to a memory or storage (e.g., any one of those depicted in FIGS. 2 and 3) as one or more instructions or routines that may be executed by a corresponding device or system to implement the process 500.

In some embodiments, at block 505, the control circuitry 220 and/or 228 may ingest input content for performing an analysis to identify sound sources within a scene or segment. The input content may be the entire media asset or a portion of the media asset. The input content may be video or audio frames and elated metadata, or other types of metadata, including closed captions.

At block 510, the control circuitry 220 and/or 228 may identify a scene or segment within the ingested input content for performing the spatialization process, as described in FIGS. 1 and 4, to identify sound sources within the scene or segment and generate spatial audio.

At block 515, the control circuitry 220 and/or 228 may determine whether the frames ingested are audio or video frames. If the control circuitry 220 and/or 228 is performing a video analysis, then it may have ingested video frames for the scene or segment such that the ingested video frames can be analyzed to identify sound sources in the scene or segment. Likewise, if the control circuitry 220 and/or 228 is performing an audio analysis, the control circuitry 220 and/or 228 may ingest audio frames of the scene or segment such that they the ingested audio frames can be analyzed to identify sound sources within the scene or segment. The process may also include ingesting of other input content, such as metadata, including closed captions.

If a determination is made at block 515 that the frames ingested are video frames, then at block 520, the control circuitry 220 and/or 228 may perform a pixel-level segmentation (e.g., using models like Mask R-CNN). Tis type of segmentation may include using the Mask R-CNN algorithm to accommodate for multiple classes and overlapping sound sources. In some embodiments, a pretrained mask may be used to segment sounds and objects and identify sound sources.

At block 525, the control circuitry 220 and/or 228 may then perform object detection, such as by using EfficientDet. This may involve the control circuitry 220 and/or 228 leveraging EfficientNet's scaling approach to uniformly scale width, depth, and resolution, along with a BiFPN (Bifurcated Feature Pyramid Network) for efficient multi-scale feature fusion. By executing the models described in blocks 520 and 525, the control circuitry 220 and/or 228 may be able to identify sound producing objects, such as vehicles or characters, and provide their spatial coordinates. The control circuitry 220 and/or 228 may also track these sound sources across frames. To do so, the control circuitry 220 and/or 228 may employ dense optical flow algorithms and Kalman filtering, enabling accurate computation of motion trajectories within the scene's spatial reference frame.

If a determination is made at block 515 that the frames ingested are audio frames then at block 530, the control circuitry 220 and/or 228 may perform frequency domain analysis (e.g., using Short-Time Fourier Transform (STFT)). Using STFT, the control circuitry 220 and/or 228 may determine how the frequency content changes over time in short segments. For example, analyzing the audio in a segment, the control circuitry 220 and/or 228 may determine current frequencies are present at present play position in the segment and how the frequency changes as the segment progresses to a second play position. Metadata relating to the changes in frequency and sound source may be generated by performing such a frequency domain analysis.

At block 535, the control circuitry 220 and/or 228 may convert time-domain signals into a time-frequency representation suitable for classification. Such conversion may allow the control circuitry 220 and/or 228 to perform a detailed analysis of sound signals and their temporal evolution that may allow it to perform audio processing, speech recognition, and other tasks for obtaining metadata that may be used for generating a spatial audio track. The control circuitry 220 and/or 228 may use the results of frequency domain analysis and data from the convert time-domain signals into a time-frequency representation to then identify sound sources within the scene or segment.

The control circuitry 220 and/or 228 may also use machine learning models, such as SoundNet, to classify sound events into categories like dialogue, footsteps, or environmental effects. The control circuitry 220 and/or 228 may also perform dynamic time warping to align these classified sounds with the visual trajectories of objects thereby ensuring accurate synchronization between audio and video data. The control circuitry 220 and/or 228 may also obtain contextual metadata from such analysis, including metadata relating to closed captions, and then parse the metadata using natural language processing models, such as BERT, to extract semantic information about sound events. Such integration may allow the control circuitry 220 and/or 228 to enhance spatial metadata with contextual descriptions, such as linking a “door slam” caption with the sound of a detected door closing and its corresponding visual motion.

FIG. 6 is an example of a scene/segment for which spatialization may be performed to generate spatial audio tracks, in accordance with some embodiments of the disclosure. In this example, a room 600 is displayed. This room 600 may be in a scene or segment of the media asset. As depicted in this scene, two individuals, 610 and 620, may be engaged in a dialogue. The room 600 may include various objects and furniture, such as a clock, painting, lamp, plant, and curtains, depicted at 625-650. Each of these objects may contribute to the room's acoustic environment as well as the sound produced by the two individuals 610 and 620. Based on the shape, size, materials of these objects 625-650, they may provide varying levels of sound absorption, resonance, reverberations, diffusion and affect the sound produced by the dialogue between the two individuals.

In addition to the two individuals, 610 and 620, engaged in the dialogue, the room 600 may also include additional sound sources are present both in the room and outside the room 600. For example, as depicted, a dog barking 660 may be inside the room while the sound of rain coming through a closed window 670, and the sound of a car passing by 680 may also be heard inside the room 600. These external or ambient sounds may affect the acoustics and overall sound experience within the room, including the dialogue. In some embodiments, the control circuitry 220 and/or 228, based on the scene, may potentially generate separate and individual spatial soundtracks for each sound source, including the human dialogue, the dog barking, the rain, and the car.

The control circuitry 220 and/or 228 may also prioritize certain sound sources based on their importance. For example, if the scene is from a movie, and the two individuals 610 and 620 are key actors, then the control circuitry 220 and/or 228 may tag them as key characters. In such cases, the generation of spatial audio data for these individuals may take precedence over other sound sources. Priority, as well as whether or not to generate spatial audio for each sound source, may be determined based on scoring, as described earlier at block 103 in FIG. 1. Such scoring may be based on factors including prominence, relevance, context, intelligibility, and AI recommendations.

To identify the sound sources, the control circuitry 220 and/or 228 may perform any one of, or a combination of, audio, video, image, closed captioning, contextual, or another type of analysis as described at block 102 of FIG. 1 The control circuitry 220 and/or 228 may also utilize visual cues to identify the sound sources in and outside the room that may affect the acoustics in the room 600. For example, the control circuitry 220 and/or 228 may take a visual cue of the rain and analyze the rain outside the window and determine the level of sound penetration, despite the window being closed. Similarly, the control circuitry 220 and/or 228 may determine the impact of the car passing by, considering its distance and the window's sound dampening effect. If the rain is too faint, the control circuitry 220 and/or 228 may ignore the sound source, however, if the window is cracked open or the rain is heavy and loud with lightning, it may consider its effect on the audio of the sound source for which a spatial audio track is being generated, such as the dialogue between the two individuals.

The control circuitry 220 and/or 228 may also incorporate various acoustic effects, such as reverberations, echoes, absorption, and diffusion, into its analysis, as described at block 104 of FIG. 1. The control circuitry 220 and/or 228 may determine prominence and the proximity of sound sources, such as a greater focus may be placed on a dog barking since the dog is more prominent and more likely to affect the acoustics of the dialogue in this scene than a car driving by.

In some embodiments, the control circuitry 220 and/or 228, getting a spatial soundtrack for the dialogue between the two individuals 610 and 620 may determine whether their dialogue has become unintelligible because of the dog's close proximity to them and the barking noise being very loud to understand or hear the dialogue properly. If the dog's barking is determined to make the unintelligible, the control circuitry 220 and/or 228 may minimize the volume of the barking in the spatial audio track generated for the dialogue.

As described in block 104 of FIG. 1, the control circuitry 220 and/or 228 may consider surroundings of the sound source and determining how such surroundings may affect the sound generated by the sound source. If the control circuitry 220 and/or 228 is generating a separate spatialized audio track for the dislodge between the individuals, it may analyze all other sound sources in and outside the room 600 as well as ambient noise. The control circuitry 220 and/or 228 may also analyze the geometry of the room 600, including its rectangular shape, and the arrangement of furniture to determine the levels of absorption, diffusion, and resonance.

In addition to the dialogue, the control circuitry 220 and/or 228, based on the analysis performed, such as video analysis, may identify the presence of dog barking alongside the speech based on visual cues as a sound source. The control circuitry 220 and/or 228 may also identify the dog based on audio analysis or closed caption analysis. Based on a video analysis, the control circuitry 220 and/or 228 and visual cues, such as rain or lightning outside the window, and a moving car, the control circuitry 220 and/or 228 may also identify the rain and car as sound source. It may also identify the car as a moving sound source. Since the car is a moving sound source, the control circuitry 220 and/or 228 may obtain the car's trajectory and the dissipation of its sound as it moves away. The control circuitry 220 and/or 228 may generate spatial metadata, incorporating all the above-mentioned factors and use the spatial metadata to generate a spatial audio track for the dialogue (or for any of the other sound sources, e.g., dog, rain, car).

Referring back to FIG. 6, in some embodiments, the control circuitry 220 and/or 228 may perform video and audio analysis to determine primary and secondary objects. For example, key characters may be identified as primary sound sources while other sounds may be categorized by the control circuitry 220 and/or 228 at a lower tier such that their spatial audio may or may not be generated and their audio may be suppressed to enhance the sound produced by the primary sound sources. In some embodiments, the control circuitry 220 and/or 228 may perform a sematic analysis to determine the context of the scene and enhance audio of certain sound source based on the context. For example, in FIG. 6, if the control circuitry 220 and/or 228 detects that the rain outside, which may be part of a storm, has caused a window to break, then based on the context, the control circuitry 220 and/or 228 may generate additional environmental sounds, such as wind, thunder, and rain, to enhance auditory continuity. This semantic inference may use pre-trained sound classification models and contextual cues from captions or object tags.

FIG. 7 is an example of a JSON structure for a moving car, in accordance with some embodiments of the disclosure. In some embodiments, the control circuitry 220 and/or 228 may identify that a sound source is a moving sound source, such as the moving car in this example. The identification may be based on audio, video, metadata (such as closed caption), or contextual analysis. The identification may also be based on visual cues. Based on the analysis, scoring (e.g., at block 103 of FIG. 1), and considerations of surroundings (e.g., at block 104 of FIG. 1), the control circuitry may generate spatial metadata describing the properties of each sound source, including its initial position, trajectory, and acoustic attributes such as Doppler effects, reverberation, occlusion, echoes, and diffusion. The spatial metadata generated in this example is that of the moving car. The control circuitry 220 and/or 228 based on the analysis may determine the car's initial (or current position) 710 and its trajectory 715. The control circuitry 220 and/or 228 may then encode with trajectory vectors and attenuation parameters to ensure precise spatial playback is performed when the spatial audio track generated for the car is played.

The overall metadata for the sound object may also include temporal metadata, such as start time, which can be used later for synchronization and playback purposes. Each sound object may be associated with a Presentation Time Stamp (PTS) that determines when it begins playback. In one embodiment, this may enable a client device to only watch scenes within a media content that are associated with sound sources/sound objects/spatial audio tracks.

In some embodiments, the spatial metadata may be formatted in machine-readable structures, such as JSON or XML. Th JSON generated, as depicted in this example, may include the object ID 705 for the car, its initial position 710, which may be the current spatial coordinates, the trajectory over time 717, all acoustic properties of the car 720, and any sound effects such as doppler 725, reverb 730, occlusion 735 that may affect the acoustics of the car.

The control circuitry 220 and/or 228 may also categorize the degree or level of the effect of the surroundings or additional details relating to the surroundings, such as doppler 725 approaching, reverb 730 being at a medium level and occlusion categorized as a low level.

FIG. 8 is an example of a JSON structure for a moving helicopter, in accordance with some embodiments of the disclosure. In some embodiments, the control circuitry 220 and/or 228 may generate a spatial audio track for a dynamic moving object, such as the moving helicopter 850. To do so, the control circuitry 220 and/or 228 encapsulates the helicopter's spatial characteristics and use them to generate the JSON file 800 representing the helicopter. This JSON file may include a unique identifier (e.g., helicopter 1 at 805), initial position 810, trajectory 820, including coordinates 822, acoustic properties 825, Doppler effects 830, reverb 835, and occlusion 840. The control circuitry 220 and/or 228 may, in real-time and dynamically, as the helicopter moves, update this metadata by analyzing video, audio, closed captions, and contextual information. If the helicopter is detected moving from its initial position 810 to a projected position 860, as represented by trajectory coordinates 822, the trajectory data may be used to generate a corresponding spatial audio track.

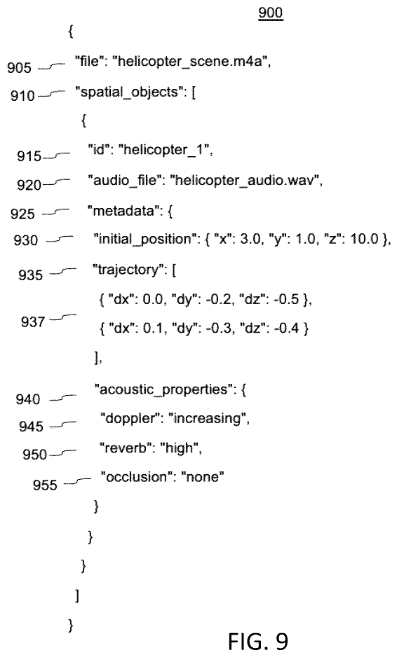

In a scenario where the helicopter moves from the background to the foreground while rotating, such movement may be captured in the spatial metadata, and a JSON file representing that spatial metadata may be generated. In such a scenario, the control circuitry 220 and/or 228 may use object tracking models and spectral analysis to identify the helicopter's visual trajectory and rotor sounds. The control circuitry 220 and/or 228 may then synchronize audio-visual elements and generate spatial metadata that reflects the synchronized audio-visual elements, such metadata may include helicopter's movement vector, Doppler shift, and rotational audio properties. All such metadata generated may be represented within a JSON format and using the JSON file the control circuitry 220 and/or 228 may generate a mezzanine file, such as the mezzanine file depicted in FIG. 9 (e.g., as represented at 905-955).

In some embodiments, the helicopter may appear in multiple episodes of a series. Although the helicopter, which has an object ID, may be the same helicopter that appears, it may be in different surroundings each time. Rather than creating the spatial audio track for the metadata from scratch each time, the control circuitry 220 and/or 228 may match the object ID through analysis of key features like color, shape, motion patterns, and sound spectral properties, and reuse previously created spatial metadata of the helicopter. The control circuitry 220 and/or 228 may then may any edits and adjustments to place the helicopter in the new setting, such as a new setting may have an occlusion when the original setting in which the original spatial metadata was created may not have had an occlusion.

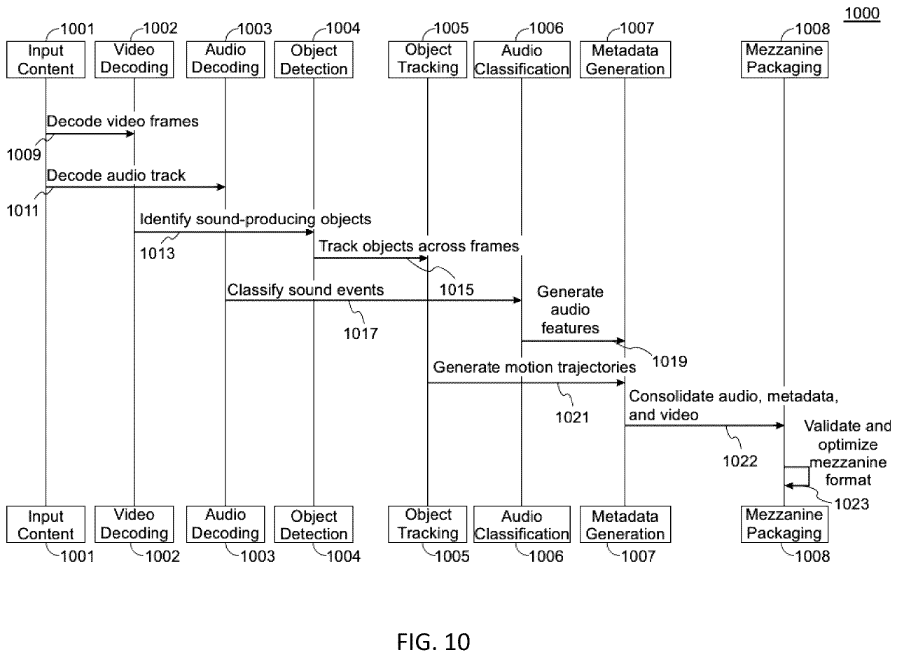

FIG. 10 is a sequence diagram of a process 1000 for tracking motion trajectories of sound sources and using them to generate spatial audio tracks and related mezzanine files, in accordance with some embodiments of the disclosure. The process 1000 may be implemented, in whole or in part, by systems or devices such as those shown in FIGS. 2 and 3. One or more actions of the process 1000 may be incorporated into or combined with one or more actions of any other process or embodiments described herein. The process 1000 may be saved to a memory or storage (e.g., any one of those depicted in FIGS. 2 and 3) as one or more instructions or routines that may be executed by a corresponding device or system to implement the process 1000.

In some embodiments, the system for identifying and tracking motion trajectories of sound sources and using it to generate spatial audio tracks and related mezzanine files may include various modules 1001-1008 that utilize hardware and software. These modules may include input content receiving module 1001, video decoding module 1002, audio decoding module 1003, object detection module 1004, object tracking module 1005, audio classification module 1006, metadata generation module 1007, and packaging module 1008. The video decoding module 1002 may use a video decoder to decode video frames, the audio decoding module may use an audio decoder to decode audio frames or received audio tracks, the object detection module may use various techniques including visual cues and audio cues to detect objects based on the video, audio, metadata provided, the object tracking module may be used for tracking a moving object, the audio classification module may be used to classify the type of sound source such as a car, a dog, sound of a helicopter, the metadata generation object module may generate spatial audio metadata reflective of the sound produced and the effects around the sound, and a mezzanine file generation module may generate a mezzanine file that can be used for generating the audio spatial track.

The process may include receiving input content 1001. The input content 1001 may be a portion or the entire media asset or a portion or level of a video game or an AR/VR experience. Once the input content is received, the control circuitry 220 and/or 228 may provide the video frames from the content to the video decoder for video decoding 1002 and provide the audio frames to the audio decoder for audio decoding 1003, as depicted at 1009 and 1011.

At 1013, the decoded video frames may be transmitted to an object detection module 1004 that may perform object detection to identify sound producing objects based on the received video frames. The object detection 1004 module may then identify the sound producing objects in the scene or segment and provide related metadata to the object tracking module 1005 at 1015 for performing object tracking 1005. The object tracking module 1005 may use the results of object tracking to generate motion trajectories at 1021 and provide such date to the metadata generation module 1007.

At 1017, the audio recording module 1003 may transmit data relating to that decoded audio track to the audio classification module 1006 for classifying different sounds that may be observed based on the audio recording. The audio classification module may then classify sounds into various classification such as speech, car sound, dog barking sound, ambient sound, or another type of classification. The classification may also identify various characteristics of the sound that is produced by the sound source. For instance, scenes with rapid object motion, high sound density, or frequent camera cuts may be classified as action scenes. Using this classification, the control circuitry 220 and/or 228 may apply optimized processing techniques that reduce the amount of computation needed for generating spatial audio metadata. For example, for scene classified as action scenes, where computational demands are typically higher, the control circuitry 220 and/or 228 may prioritize processing of primary sound sources (e.g., explosions, car engines) and de-emphasizes secondary or ambient sounds. For instance, explosions and vehicle movements may be spatialized with full metadata, while background crowd noise may be represented as a diffuse sound with reduced spatial metadata. This selective processing approach may allow the control circuitry 220 and/or 228 to reduce processing load without significantly impacting audio fidelity.

At 1019, based on the audio classification, the metadata generation module 1007 may generate audio features relating to the sound source. The metadata generation module 1007 may also receive generated motion trajectories 1021 from the object tracking module 1005. In some embodiments the metadata generation module 1007 may receive data relating to objects that are being tracked across frames from the object tracking module and the metadata generation module 1007 may generate the motion trajectories. At 1022, the metadata generated, which is the spatial metadata, may be provided to the mezzanine packaging module 1008. The mezzanine packaging module 1008 may consolidate all audio, metadata and video and perform a validation and optimization process to then generate a mezzanine format file at 1023. The mezzanine file may be in a format that adheres to established standards such as Dolby Atmos or MPEG-H Audio to ensure compatibility with downstream systems. Each audio track generated may be processed and isolated as an independent spatial audio object and tagged with its corresponding metadata, including position, trajectory, and acoustic properties. The metadata may be embedded as auxiliary data stream and be stored separately or multiplexed within the container alongside the audio data. The components may then be packaged into a single container, such as an MP4 file with MPEG-H streams or an ADM file for Dolby Atmos.

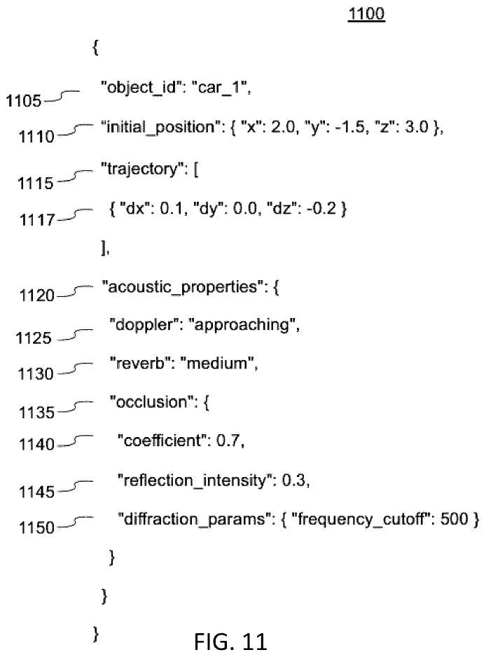

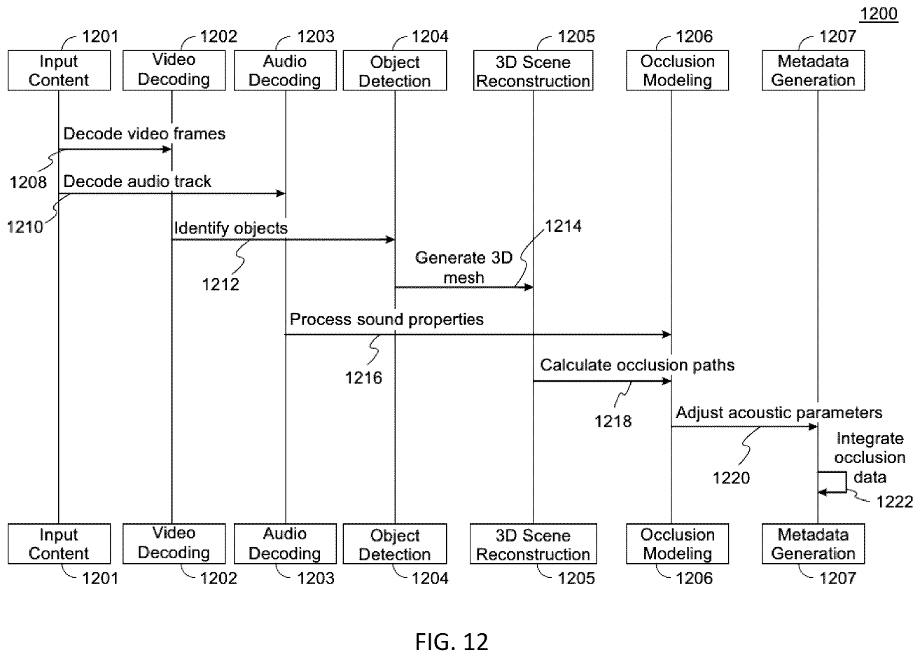

FIG. 11 is an example of a JSON structure for a sound source that partially occluded for which a spatial audio track is generated using the process of FIG. 12, in accordance with some embodiments of the disclosure. The process 1200 may be implemented, in whole or in part, by systems or devices such as those shown in FIGS. 2 and 3. One or more actions of the process 1200 may be incorporated into or combined with one or more actions of any other process or embodiments described herein. The process 1200 may be saved to a memory or storage (e.g., any one of those depicted in FIGS. 2 and 3) as one or more instructions or routines that may be executed by a corresponding device or system to implement the process 1200.

In some embodiments, the system for generating spatial audio tracks and related mezzanine files for partially occluded sound sources may include an input receiving module 1201, video decoding module 1202, audio decoding module 1203, object detection module 1204, 3D scene reconstruction module 1205, occlusion modelling module 1206, and metadata generation module 1207. The video decoding module 1202 may use a video decoder to decode video frames, the audio decoding module may use an audio decoder to decode audio frames or received audio tracks, the object detection module may use various techniques including visual cues and audio cues to detect objects based on the video, audio, metadata provided, the 3D scene reconstruction module may be used to reconstruct a 3D scene where the sound source is location, occlusion modelling module may be used to model the occlusion that may affect the acoustics of the sound source, and the metadata generation module may generate spatial audio metadata reflective of the sound produced and the other sounds and surrounding that effects the sound generated.

In some embodiments, the control circuitry 220 and/or 228 may incorporate dynamic occlusion modeling to enhance the realism of spatial audio by simulating the effects of physical obstructions on sound propagation. The control circuitry 220 and/or 228 may achieve this by analyzing the 3D spatial relationships between moving sound sources, stationary listeners, and the scene geometry. The control circuitry 220 and/or 228 may, based on the analysis, dynamically calculate sound attenuation, reflection, and diffusion caused by occlusions. The process of doing so may be initiated by the control circuitry 220 and/or 228 reconstructing a 3D scene using visual data from video frames. Depth information may be extracted using monocular depth estimation models, such as MiDaS, or stereo disparity techniques when stereoscopic input is available. These depth maps may be used to generate a mesh of the scene geometry, which may provide a detailed representation of potential occluding surfaces, such as walls, furniture, or other large objects.

For each moving sound source identified in the audio-visual analysis, the control circuitry 220 and/or 228 may calculate potential occlusion paths using ray tracing techniques. These techniques may include casting a set of rays from the listener's position (which corresponds to the camera or viewer perspective) to the sound source, i.e., the sound source. Intersections with the scene mesh may be identified. These intersections may be used by the control circuitry 220 and/or 228 to determine the extent of occlusion and its effects on sound intensity and characteristics.

To compute the occlusion effects, the control circuitry 220 and/or 228 may apply physical models of sound propagation, accounting for diffraction, absorption, and reflection. For example, if a character speaking moves behind a wall in a scene, the control circuitry 220 and/or 228 may calculate how the wall attenuates and filters their voice. High-frequency components may be reduced by the control circuitry 220 and/or 228 due to absorption, while low-frequency sounds diffract around the wall and reach the listener with reduced intensity. For example, as a car drives past a building the control circuitry 220 and/or 228 may perform occlusion modeling and adjust the sound properties to reflect the transition from a direct path to a partially obstructed path, and back to a direct path as the car emerges from behind the building.

Once the occlusion metadata is generated, the control circuitry 220 and/or 228 may integrate it into the spatial audio metadata and encode it into the mezzanine format. This metadata may include parameters such as the occlusion coefficient (a measure of sound attenuation), reflection intensity, and diffraction parameters. An example JSON metadata entry for a partially occluded sound source is depicted in FIG. 11.

Referring to FIG. 12, steps 1208-1212 may be similar to steps 1009-1013 in FIG. 10. At 1214, once objects are identified, the 3D reconstruction module 1205 may reconstruct the 3D scene using visual data from video frames. It may extract depth information and depth maps to generate a mesh of the scene geometry, such as a 3D mesh of the room in FIG. 6 which includes various objects such as furniture, clock, painting, lamp, plant, and curtains, depicted at 625-650. In some embodiments, objects that exceed a size threshold may be the only objects considered.

At 1216, based on the audio decoding performed by the audio decoding module, and the sound properties identified, the occlusion modeling module 1206 may generate an occlusion model. This modelling may include computing occlusion effects by applying physical models of sound propagation, accounting for diffraction, absorption, and reflection. This occlusion modeling may be used to adjust the sound properties to reflect the transition from a direct path to a partially obstructed path.

At 1220, the metadata generation module may receive the adjusted acoustic sound properties and may generate spatial metadata for the sound generated by the sound source considering the occlusion data. Once the occlusion metadata is generated, a JSON structure may be generated and used to generate a mezzanine file. As depicted, the JSON structure, such as the JSON structure in FIG. 11, may include an object ID 1105 for the car, and initial position 1110, the trajectory 1115 of the car, including the projected coordinates of the trajectory 1117, acoustic properties 1120, Doppler 1125, reverb 1130, occlusion data 1135, a coefficient of occlusion 1140, a reflection intensity 1145, and diffraction parameters 1150.

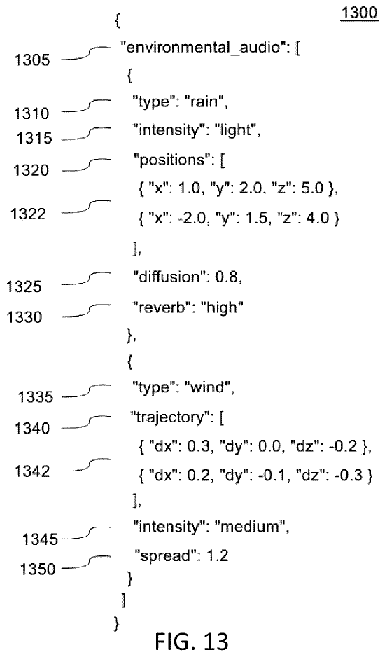

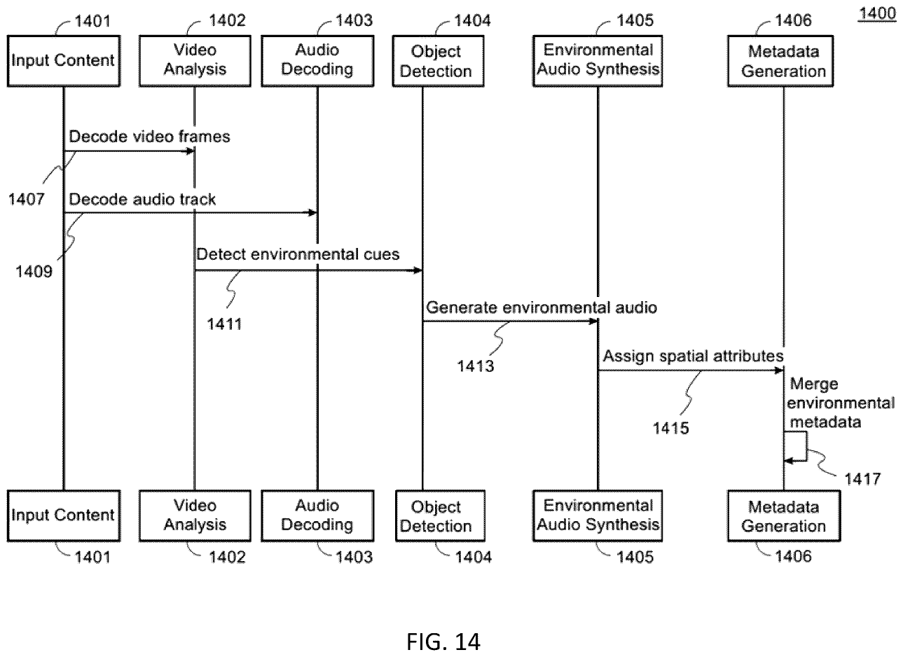

FIG. 13 is an example of a JSON structure for incorporating surrounding environment sounds that affect the acoustics of the sound source for generating spatial audio tracks, in accordance with some embodiments of the disclosure and FIG. 14 is a sequence diagram of a process 1400 for incorporating surrounding environment sounds that affect the acoustics of the sound source for generating spatial audio tracks, in accordance with some embodiments of the disclosure.

In the embodiments of FIGS. 13 and 14, the control circuitry 220 and/or 228 may integrate environmental audio effects, such as rain, wind, or fire, into spatial audio tracks to enhance immersion and realism. The control circuitry 220 and/or 228 may perform the integration by synthesizing or modifying ambient audio elements based on visual cues from the scene and the spatial context derived from metadata. For example, if the spatial cues show rain outside a window, such as in FIG. 6, then the control circuitry 220 and/or 228 may take guidance from those visual cues to perform the synthesizing or modifying.

In some embodiments, to perform the integration and merge environmental metadata to generate a spatial audio track, the control circuitry 220 and/or 228 may utilize various modules, such as modules 1401-1406. These modules may include input content receiving module 1401, video analysis module 1402, audio decoding module 1403, object detection module 1404, environmental audio synthesis module 1405, and metadata generation module 1406. The input content receiving module 1401 may be used to receive content, such as a media asset, video game, AR/VR experience, a game, an episode or series of episodes, etc. The video analysis module 1402 may be used to analyze video of a scene or segment and decode video frames of the scene of segment. The audio decoding module 1403 may use an audio decoder to decode audio frames or received audio tracks. The object detection module 1404 may use various techniques including visual cues and audio cues to detect objects based on the video, audio, metadata provided. The environmental audio synthesis module 1405 may be used for performing audio syntheses and the metadata generation module 1406 may generate spatial audio that includes merges environmental metadata.

The control circuitry 220 and/or 228 may perform the integration process by using the input content module 1401 to ingest the content. At 1407, the control circuitry 220 and/or 228 may use the video analysis module 1402 to analyze video frames using object detection and segmentation models such as Mask R-CNN or DeepLabv3+. These models may be used to identify visual cues associated with environmental conditions, such as raindrops, moving leaves, or flames, as depicted at 1411 where the environmental cues are detected by the object detection module 1404. For example, the density and distribution of detected raindrops may be quantified by the control circuitry 220 and/or 228 to estimate the intensity and area of rainfall in the scene.

Based on these visual cues, the control circuitry 220 and/or 228, at 1413, may use the environmental audio synthesis moule 1405, to generate environmental audio by synthesizing environmental audio using procedural audio generation. For example, granular synthesis may be used to create realistic rain sounds by combining short audio grains sampled from pre-recorded rain clips, modulated in amplitude and frequency to match the density of raindrops detected in the scene. Additionally, existing environmental audio, which may be decoded at 1409, from the input track may be enhanced or modified to align with the detected visual cues, ensuring coherence between audio and video components. Spatialization of environmental sounds may be achieved by the metadata generation module at 1415, by assigning them positions, trajectories, and acoustic properties. For instance, the sound of wind rustling through trees may be spatialized to move laterally across the scene, following the detected motion of tree branches. This metadata may include parameters such as spatial diffusion (how widely the sound spreads) and reverberation (how the sound interacts with the environment). The control circuitry 220 and/or 228, based on the metadata created by the metadata generation module at 1406 at 1415 and 1417, which includes the merges environmental metadata, may encode the environmental audio metadata into the mezzanine format alongside other sound sources. The mezzanine format may allow downstream playback systems to dynamically adapt these ambient effects based on the listener's environment. For example, rain sounds can be rendered louder in a surround-sound setup or adjusted for subtlety in headphone playback.

In another example, imagine a scene where a character is walking through a forest on a windy day with light rainfall. The control circuitry 220 and/or 228 may detect tree motion caused by wind through analysis described in above embodiments and identify raindrops in the frame through segmentation. The detected cues may be used to synthesize corresponding audio effects, such as wind sounds may be synthesized and assigned spatial trajectories that move from left to right, matching the motion of tree branches. Likewise, rain intensity may be mapped to light, with sparse raindrop sounds synthesized at random intervals and spatialized across the scene. One example of JSON structure for the metadata for these sounds is depicted in FIG. 13.

As depicted, in FIG. 13, the environmental audio data 1305 may include two types of environmental audio spatial data, e.g., for the rain and the wind. With respect to the rain audio data 1310, the JSON structure may indicate its intensity 1315, which may be categorized as light intensity, its position and associated coordinates of the rain sound, which is at 1322, and surrounding effects which include diffusion 1325 at 0.8 and reverb 1330 as high. Another environmental audio which is wind 1335 may also be included in the JSON structure period since the wind has a trajectory, the trajectory 1340 may be indicated based on the coordinates of the trajectory 1342 and the JSON structure may also identify the intensity of the wind which is in this example depicted at 1345 at medium intensity and having a spread of 1.2.

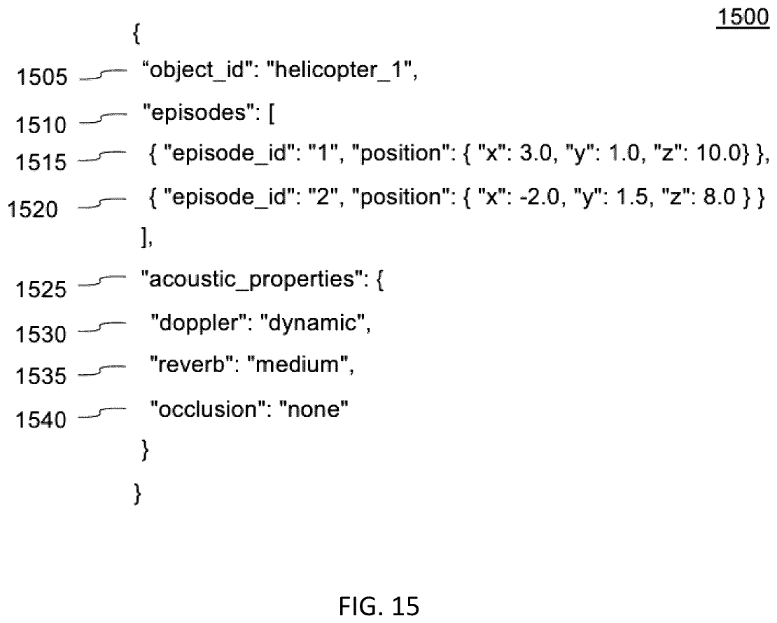

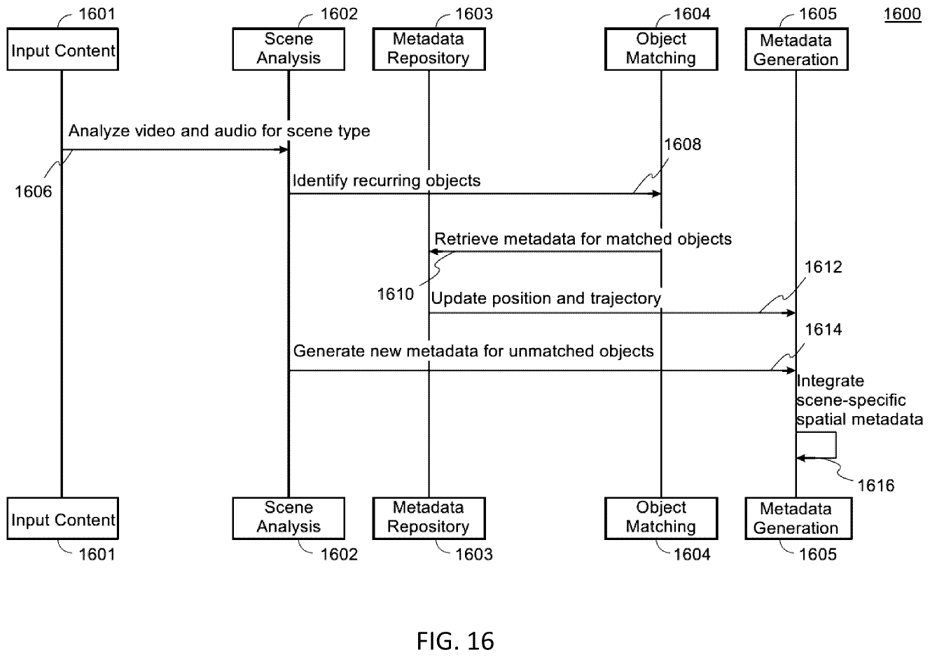

FIG. 15 is an example of a JSON structure for integrating sound produced by recurring sound sources into spatial metadata that is to be used to generate spatial audio tracks, in accordance with some embodiments of the disclosure and FIG. 16 is a sequence diagram of a process 1600 for integrating recurring sound sources into spatial metadata that is to be used to generate spatial audio tracks, in accordance with some embodiments of the disclosure.

In some embodiments, the control circuitry 220 and/or 228 may optimize the processing of spatial audio for specific types of scenes in movies, such as action scenes, by reducing computational complexity and enabling metadata reuse across episodes in a series or similar scenes in a single movie or across related movies, such as sequels and prequels. This approach may minimize redundant calculations while maintaining high-quality spatial audio playback.

In some embodiments, to perform the integration of the recurring sound sources into spatial metadata that is to be used to generate spatial audio tracks, the control circuitry 220 and/or 228 may utilize various modules, such as modules 1601-1605. These modules may include input content receiving module 1601, scene analysis module 1602, metadata repository module 1603, object matching module 1604, and metadata generation module 1605. The input content receiving module 1601 may be used to receive content, such as a media asset, video game, AR/VR experience, a game, an episode or series of episodes, etc. The scene analysis module 1602 may be used to analyze the scene of segment in which the sound source appears for the first time. The metadata repository module 1603 may store object IDs of the sound source identified in the first scene or segment, where the object IDs may be assigned to each separate sound source, such as a specific object ID for a helicopter that appears in the first scene, first episode, etc. The object matching module 1604 may use to match sounds objects across various frames, scenes, segments, episodes, or levels of a game, or across any two pieces of content in which the same sound source appears. For example, if a helicopter appears in a first scene and then again in an eighth scene, the object matching module 1604 may be used to determine a match between the sound sources to confirm that it is the same sound source, such as the same helicopter appearing in both first and eighth scene.

The process 1600 to perform the integration of the recurring sound sources into spatial metadata that is to be used to generate spatial audio tracks may include the control circuitry 220 and/or 228 utilizing the input content module 1601 to ingest the input content, which may be, for example a scene in the media asset.

At 1606, the scene analysis module 1602 may analyze video and audio for the ingested scene. The scene analysis module 1602 may analyze video frames using object detection and segmentation models such as Mask R-CNN or DeepLabv3+. These models may be used to identify visual cues associated with recurring objects. In some embodiments, the scene analysis module 1602 may identify action scenes by analyzing video and audio patterns that match predefined criteria. For instance, scenes with rapid object motion, high sound density, or frequent camera cuts may be flagged as action scenes. Using this classification, the control circuitry 220 and/or 228 may apply optimized processing techniques that reduce the amount of computation needed for generating spatial audio metadata. In action scenes, where computational demands are typically higher, the control circuitry 220 and/or 228 prioritize processing of primary sound sources (e.g., explosions, car engines) and de-emphasizes secondary or ambient sounds. For instance, explosions and vehicle movements may be spatialized with full metadata, while background crowd noise may be represented as a diffuse sound with reduced spatial metadata. This selective processing approach may allow reduction of processing load without significantly impacting audio fidelity.

For recurring content, such as TV series or in a sequel or a prequel of a movie, the control circuitry 220 and/or 228 may reuse metadata generated for recurring objects across episodes or similar scenes. For example, if a helicopter appears in multiple episodes of a series and maintains the same visual and auditory characteristics, the control circuitry 220 and/or 228 may match, such as by using the object matching module 1604, the object ID using a persistent identifier and reuses its spatial metadata. Object matching may be performed by analyzing key visual and acoustic features, such as color, shape, motion patterns, and spectral properties of the sound.

When an object is matched by the object matching module 1604, the control circuitry 220 and/or 228, at 1610, may retrieve metadata for the matched objects. This include retrieving its previously generated metadata. The control circuitry 220 and/or 228, using the metadata generation module 1605, may then adapt it to the new scene, such as at 1612 by updating its position and trajectory. For instance, if the helicopter appears at a different angle or altitude in a new episode, only the position and trajectory parameters are adjusted, while acoustic properties such as Doppler effects and reverberation are retained. The control circuitry 220 and/or 228, at 1614, based on the scene analysis of the new scene, may generate new metadata for the unmatched objects and provide that to the metadata generation module 1605 to generate new spatial metadata for them.

One example of reusing previously generated metadata for the recurring objects may be a movie with a high-action chase sequence involving cars and a helicopter. In this example, if the same helicopter appears in multiple scenes, then the control circuitry 220 and/or 228 may reuse the metadata generated for the helicopter in a prior scene by matching its object ID and saving time and computational resources. Adjustments may be made to the helicopter sound in the new scene, such as to its trajectory and position, to reflect changes in the new scene's context.

An example of a JSON structure generated based on process 600, as depicted in FIG. 15, may be used for updating position from a first occurrence to a second occurrence of the recurring sound source.

In this example, a helicopter may be assigned an object ID at 1505, which may be “helicopter_1.” An identification may be made that the same helicopter appears in multiple episodes 1510. At 1515, the JSON structure may indicate that the same helicopter appears in episode 1 at a particular position. At 1520, the JSON structure may indicate that the same helicopter may appear again in a later episode, which is episode 2, at a different position. Based on identifying that the helicopter is a recurring object and its changed position in episode 2, the new scenes acoustic properties which include Doppler, reverb, and occlusion may be adjusted by the control circuitry 220 and/or 228 using the process 1600. In some embodiments, such data can be used to determine whether to cache spatial audio track(s) for sound sources that appear multiple times within the content item (e.g., episode) or that appear in a subsequent related content item (e.g., subsequent episode), during stream of the content to a user device, or content that appears across related media assets, such as a prequel or sequel of a movie. The caching may occur locally on the user's device and a profile associated with the user profile may indicate whether the user is binge-watching a show (i.e., like to play the subsequent episode). Flagging such commands to the player may occur in a variety of ways, including signaling via the manifest file associated with the content item or through other means that associate caching instructions for specific spatial audio tracks.

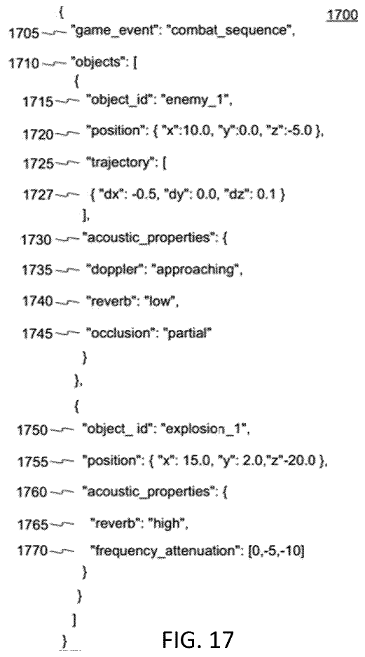

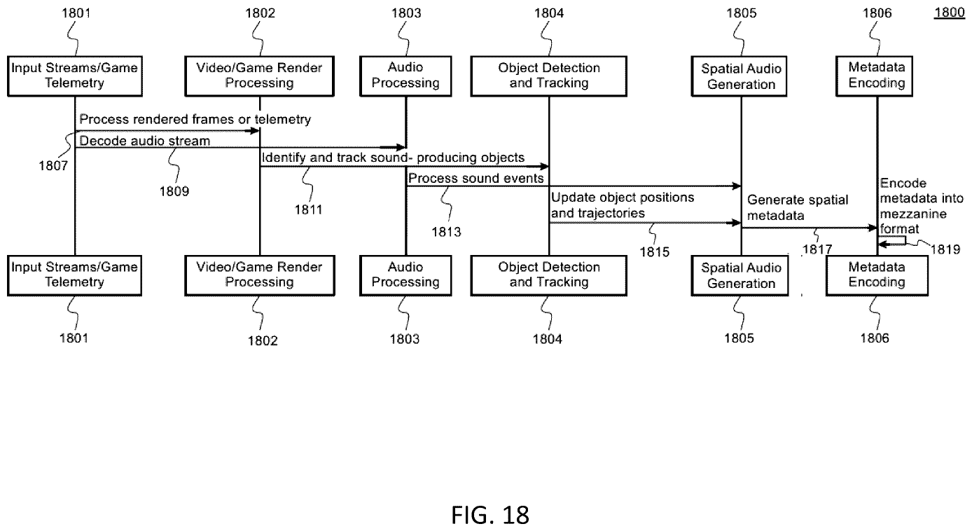

FIG. 17 is an example of a JSON structure for a video game, in accordance with some embodiments of the disclosure and FIG. 18 is a sequence diagram of a process 1800 for generating spatial audio tracks and related mezzanine files for sound sources in a video game, in accordance with some embodiments of the disclosure.

In some embodiments, in a gaming scenario such as Call of Duty or in a virtual or augmented reality scenario, the control circuitry 220 and/or 228 may detect an approaching enemy through in-game telemetry or rendered frames. Footstep sounds are spatialized based on the enemy's detected trajectory, and frequency attenuation may be applied as the player looks away from the sound source. Simultaneously, an explosion in the distance may be localized and rendered with directional reverberation, creating an immersive audio experience.

In some embodiments, to perform the generation of spatial audio tracks and related mezzanine files for sound sources in a video game, the control circuitry 220 and/or 228 may utilize various modules, such as modules 1801-1806. These modules may include input streams/game telemetry module 1801, video/game render processing module 1802, audio processing module 1803, object matching module 1804, spatial audio generation module 1805, and metadata encoding module 1806.

The process 1800 to generate spatial audio tracks and related mezzanine files for sound sources in a video game may include the control circuitry 220 and/or 228 utilizing the input streams/game telemetry module 1801 to receive input streams or game telemetry input. These input streams may include the entire game, a portion of the game, such as a particular level of the game, or a particular scenery or a room in the game such as in the game of Call of Duty which has a plurality of rooms or spaces.

Input streams or the game telemetry received may be provided to the video/game render processing module 1802, which may process, at 1807, the rendered frames or telemetry received. The video/game render processing module 1802, at 1811, after processing the rendered frames or telemetry, may then provide the rendered frames or telemetry to the object detection and tracking module 1804 for identifying and tracking sound producing objects. The object detection and tracking module 1804 may provide the identification of the sound production objects to the spatial audio generation module 1805 for updating object positions and trajectories.

The input streams or the game telemetry received may also be provided to the audio processing module 1803, which may process, at 1809, decode the received audio stream. Once the audio stream is processed, the related data may be provided to the spatial audio generation module 1805.

The spatial audio generation module 1805 having received data from the audio processing module 1803 and the object detection and tracking module 1804 may then process sound events at 1813 and object position and trajectories at 1815. The spatial audio generation module 1805 may then provide the processed data relating to the sound events and object position and trajectories to the metadata encoding module 1806 for generating spatial metadata. The metadata encoding module 1806 may encode the generated metadata into the mezzanine format at 1819.

An example of a JSON structure generated based on process 1800, as depicted in FIG. 17, may be used for generating spatial audio tracks and related mezzanine files for sound sources in a video game. As shown, the JSON structure may have an identification or a title of the video game, or for a scene or segment within the video game, such as “game_event”:“combat_sequence.” It may also include an object ID for an event or a sound source approaching the user, such as object ID enemy_1 at 1715. It may also include the position and trajectory of the enemy at 1720-1727. It may also include acoustic properties 1730, Doppler 1735, reverb 1740, and occlusion 1745 data. Similarly, the JSON file may also include an object ID for another sound source which may be an explosion 1750. Relating to the explosion, the JSON file may also include the explosion's position 1755, acoustic properties 1760, reverb 1765 and frequency attenuation 1770.

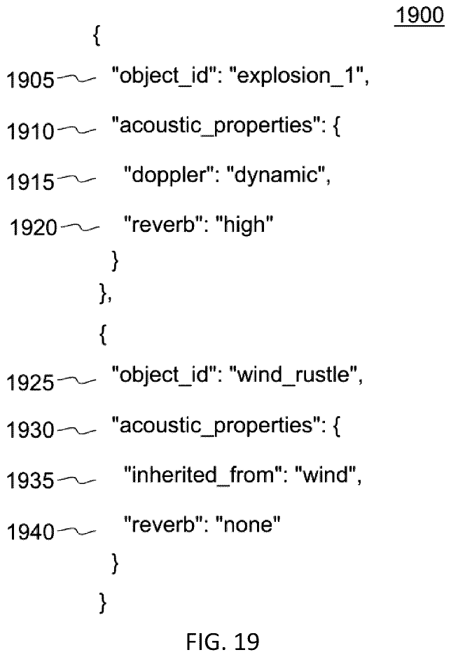

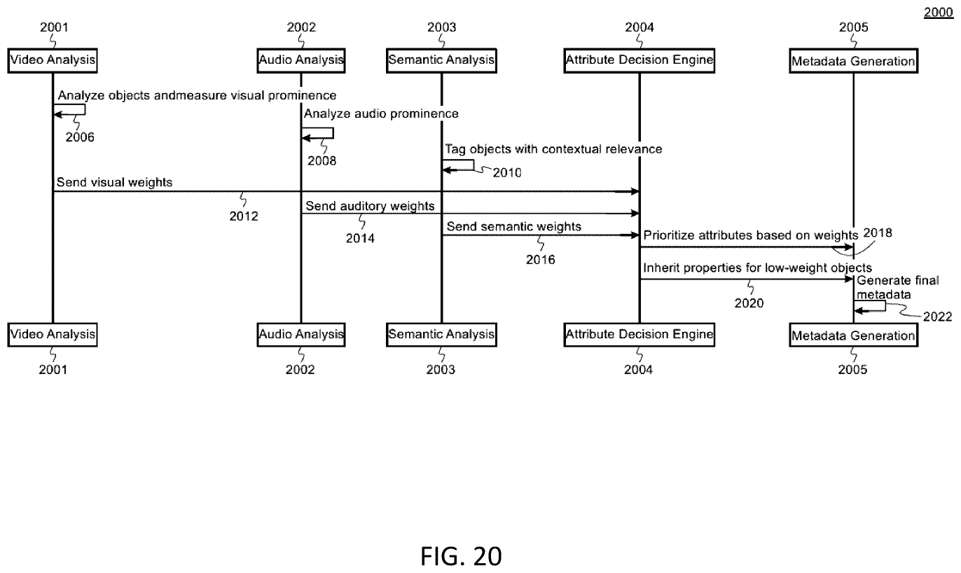

FIG. 19 is an example of a JSON structure for using factors such as prominence, and semantics, for determining priority in generating spatial audio tracks and related metadata for sound sources, in accordance with some embodiments of the disclosure, and FIG. 20 is a sequence diagram of a process 2000 for using factors such as prominence, and semantics, for determining priority in generating spatial audio tracks and related metadata for sound sources, in accordance with some embodiments of the disclosure.

In the embodiments of FIGS. 19 and 20, the control circuitry 220 and/or 228 may update the soundscape frame-by-frame to synchronize audio events with on-screen actions. This ensures that changes in the environment, such as camera zooms, pans, or scene transitions, are reflected in the spatial positioning and volume of audio sources. For instance, as the camera zooms in on a character, their dialogue becomes more prominent, and ambient noise is attenuated to focus the listener's attention or in a video gaming scenario, as the virtual camera zooms in on an enemy, sound produced by the enemy may become more prominent and other sounds may be minimized or removed.

To synchronize audio events with on-screen actions, the control circuitry 220 and/or 228 leverages real-time scene analysis to adjust the audio mix dynamically. If an explosion occurs off-frame but shifts into view due to a camera pan, the control circuitry 220 and/or 228 may gradually increase its volume and adjusts its position in the audio field to reflect its on-screen trajectory. This dynamic adaptation ensures seamless synchronization between visual and auditory elements.

In some embodiments, the synchronize audio events with on-screen actions may manage off-screen sounds to maintain an immersive audio experience. Sounds originating outside the visible frame, such as a car passing behind the listener or dialogue from an off-screen character, may be positioned in the audio field to reflect their virtual location. The control circuitry 220 and/or 228 calculates the direction and distance of off-screen sounds using spatial metadata and renders them with appropriate spatial cues, such as attenuation and reverb, to convey their position. For example, if a car drives off the screen to the left and continues behind the listener, the control circuitry 220 and/or 228 may dynamically pan the sound from front-left to rear-left, maintaining the realism of its movement.

In some embodiments, the process for using factors such as prominence, semantics, for determining priority in generating spatial audio tracks and related metadata for sound sources may be performed by the control circuitry 220 and/or 228, which may leverage various modules, such as modules 2001-2005. These modules may include video analysis module 2001, audio analysis module 2002, semantic analysis module 2003, attribute detection engine 2004, and metadata generation module 2005. The video analysis module 2001 may be used for analyzing objects and measuring visual prominence. The audio analysis module 20 02 may be used for analyzing audio prominence. The semantic analysis module 2003 may be used for tagging objects with contextual relevance. The attribute decision engine 2004 may be used for prioritizing attributes based on their weights and inheriting properties for low weighted objects. The metadata generation module 2005 may generate the final metadata that includes visual and audio prominence as well as contextual relevance and semantic weights.

In some embodiments, the process 2000 for using factors such as prominence, semantics, for determining priority in generating spatial audio tracks and related metadata for sound sources may include the control circuitry analyzing video and audio inputs to identify objects and their associated sound sources. Using object detection models, such as Mask R-CNN, the control circuitry 220 and/or 228, and using the video analysis module 2001, the control circuitry 220 and/or 228 may determine the visual prominence, at 2006, of each object by measuring its screen space coverage. For example, a large explosion covering 20% of the screen would have a higher visual weight than a leaf rustling in a corner. These visual weights may then be normalized across the scene to prioritize the calculation of acoustic attributes for more prominent objects.

Likewise, the control circuitry 220 and/or 228, and using the audio analysis module 2002, may determine the auditory prominence, at 2008, of each object. The auditory prominence may be derived from existing audio features, such as volume or spectral density. For instance, if the scene includes loud engine noises, the control circuitry 220 and/or 228 may deprioritize calculating acoustic attributes for subtle environmental sounds such as wind.

Utilizing the semantic analysis module 2003, the control circuitry 220 and/or 228, at 2016, may determine the semantic weights, such as by using natural language processing (NLP) and sound classification models, which infer the contextual relevance of objects. For example, if a semantic tag indicates the scene is outdoors, the control circuitry 220 and/or 228 may bypass reverb calculations for all objects since reverberation is less relevant in open spaces.

Utilizing the attribute decision engine 2004, the control circuitry 220 and/or 228, at 2018 and 2020, may prioritize attributes based on their semantic weights and inherit properties for low-weight objects. To do so, the control circuitry 220 and/or 228 may calculate acoustic attributes for each object based on its weighted prominence. If an object's combined weight falls below a predefined threshold, the control circuitry 220 and/or 228 may inherit its acoustic properties from similar objects. For example, if Doppler effects have already been calculated for one ambulance, a second detected ambulance may inherit these attributes, reducing redundant computations. Conversely, if a leaf rustling sound is below the threshold but semantically similar to other environmental sounds (e.g., wind), the control circuitry 220 and/or 228 may inherit acoustic properties from those sounds. In another embodiment, the control circuitry 220 and/or 228 may dynamically determine which acoustic attributes to calculate for sound sources based on their visual, auditory, and semantic significance within the scene. This approach optimizes computational resources by prioritizing objects that have a higher contextual impact while simplifying or omitting calculations for less relevant elements.

In an example scenario involves a scene with a large explosion and subtle wind rustling through trees, the control circuitry 220 and/or 228 may calculate directional and reverberation properties for the explosion, omitting calculations for wind rustling due to its low combined weight.

The control circuitry 220 and/or 228 output a JSON structure the includes metadata generated from process 2000, such as the JSON structure at FIG. 19. As depicted, the JSON structure, in this example, may include metadata for an explosion and the wind rustle. In this example, the object ID for the explosion at 1905 may be “explosion_1. The JSON structure may include the explosion's acoustic properties, Doppler effect, and reverb at 1910-1920. The JSON structure may also include an object ID for the wind rustle 1925. It may also include the wind rustle's acoustic properties, data describing where the acoustic properties were inherited from, and the reverb. Since the wind rustle, as described earlier, is a subtle sound, it may inherit properties from a similar sound source, which in this case is the wind 1935.

In some embodiments, the control circuitry 220 and/or 228 may synchronize audio events with on-screen actions and provide user controls to adjust the intensity of spatial effects, such as distance perception, ambient noise levels, and reverb. The control circuitry 220 and/or 228 may generate a user interface on a ser device that allows listeners to customize their experience based on their preferences or environmental conditions. For example, users may be able to amplify dialogue while reducing ambient effects for clarity or increase reverb to simulate a concert hall environment.

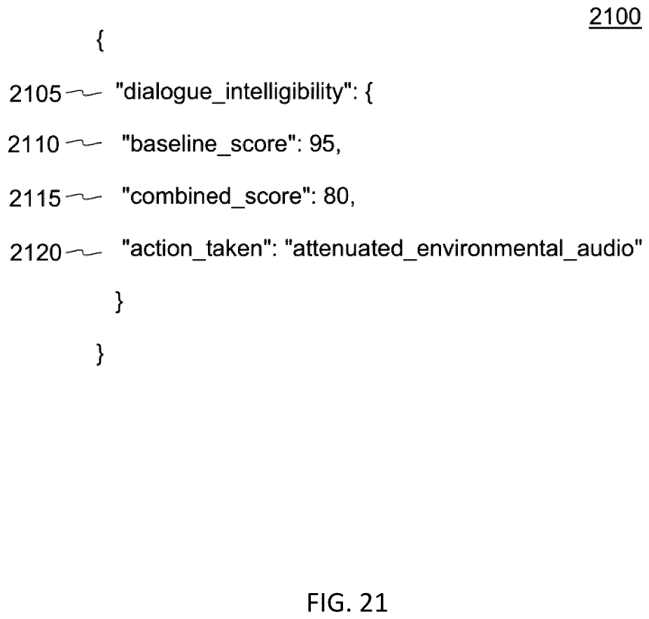

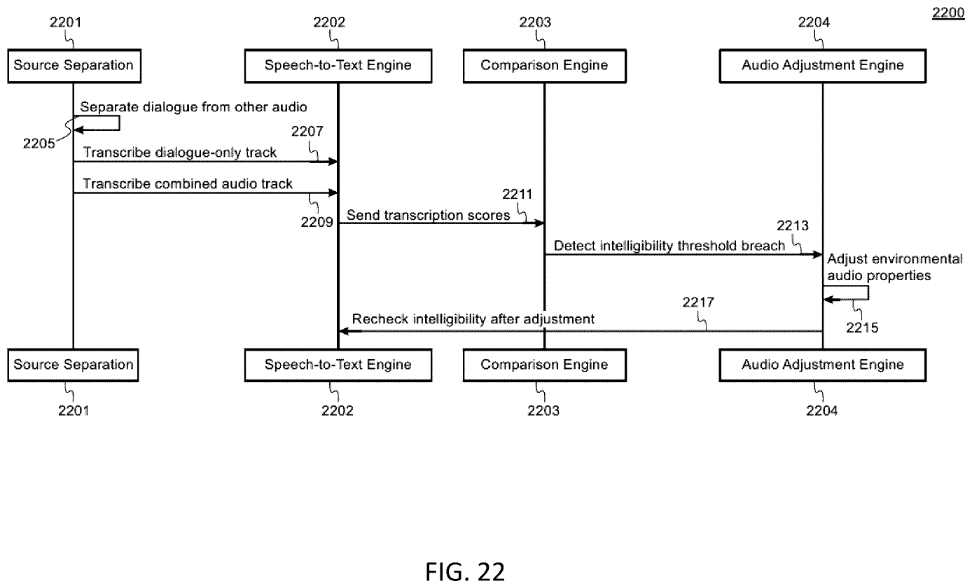

FIG. 21 is an example of a JSON structure for determining dialogue intelligibility and making appropriate adjustments when generating spatial audio tracks for sound sources, in accordance with some embodiments of the disclosure and FIG. 22 is a sequence diagram of a process 2200 for determining dialogue intelligibility and making appropriate adjustments when generating spatial audio tracks for sound sources, in accordance with some embodiments of the disclosure.

In some embodiments, the control circuitry 220 and/or 228 may maintain dialogue intelligibility by dynamically adjusting environmental audio effects based on real-time transcription accuracy. To do so, the control circuitry 220 and/or 228 may utilize various modules, such as modules 2201-2204. These modules may include separation module 2201, a speech to text engine 2202, the comparison engine 2203, and an audio adjustment engine 2204. The source separation module 2201 may be used by the control circuitry to separate dialogue from other audio. The speech to text engine 2202 may be used by the control circuitry to transcribe dialogue only tracks and combined audio tracks. The comparison engine 22/03 may be used by the control circuitry to calculate and send transcription scores. The audio adjustment engine 2204 may be used by the control circuitry to detect intelligibility threshold breach and adjust environmental audio properties based on the extent of the breach. It may also be used for rechecking intelligibility after an adjustment has been made.

The process may include the control circuitry 220 and/or 228, at 2206, using the source separation module 2201 to separate dialogue from other audio. In this embodiment, the other audio may be any ambient noise, or any other sound being produced by another sound source. The control circuitry 220 and/or 228 may begin the process of separating dialogue from other audio components using source separation models like Open-Unmix. The dialogue track is analyzed using NLP models to generate a real-time transcription.

Once the dialogue is separated, the control circuitry 220 and/or 228 may use the speech-to-text engine 2202, to perform speech-to-text analysis on combined audio tracks to evaluate dialogue legibility. If the transcription accuracy falls below a predefined threshold or the change in accuracy exceeds a certain limit, the control circuitry 220 and/or 228 may limit the volume or number of environmental effects to prioritize dialogue clarity.

Simultaneously, the control circuitry 220 and/or 228 may use the speech-to-text engine 2202 to transcribe the combined audio track, including environmental effects.

The transcribed data may then be sent to the comparison engine 2203 to then generate intelligibility scores, at 2211, based on the intelligibility of the transcription. The comparison engine 2203 may then compare the intelligibility scores between the dialogue-only and combined transcriptions. If the combined intelligibility score deviates by more than a threshold (e.g., 10%), the control circuitry 220 and/or 228, using the audio adjustment engine 2204, may attenuates or removes competing audio effects, such as at 2215. For example, in a scene with dialogue overlaid with rain and thunder sounds, if the transcription accuracy for the dialogue-only track is 95% but drops to 80% in the combined track, the control circuitry 220 and/or 228 may utilize the audio adjustment engine 2204 to reduce the volume of rain and thunder to restore intelligibility. An example of a JSON structure that is reflective of comparing the intelligibility scores and attenuating or removing competing audio effects is depicted in FIG. 21. The JSON structure may include dialogue intelligibility reference 2105 and indicate the baseline score 2110, the combined score 2115, and the attenuation action to be taken 2120 if the score falls below a threshold, i.e., the associated dialogue is deemed intelligible.

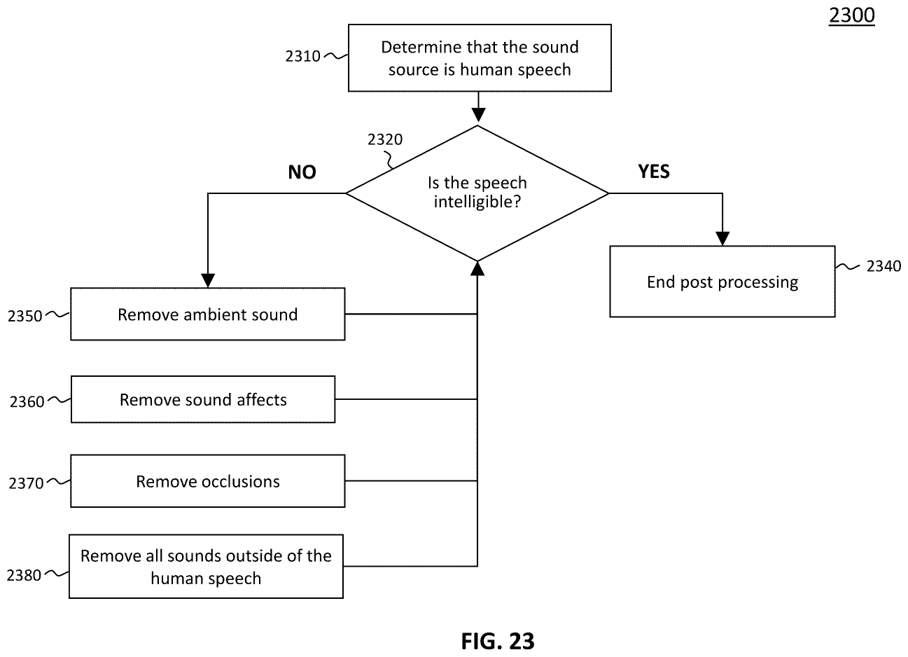

FIG. 23 is a flowchart of a process 2300 for performing post processing for human speech to make its sound quality intelligible, in accordance with some embodiments of the disclosure. The process 2300 may be implemented, in whole or in part, by systems or devices such as those shown in FIGS. 2 and 3. One or more actions of the process 2300 may be incorporated into or combined with one or more actions of any other process or embodiments described herein. The process 2300 may be saved to a memory or storage (e.g., any one of those depicted in FIGS. 2 and 3) as one or more instructions or routines that may be executed by a corresponding device or system to implement the process 2300.

In some embodiments, at block 2310, the control circuitry 220 and/or 228 may determine that the sound source is human speech or dialogue. Once the detection is made that the sound source is human speech or dialogue that is produced by a human, such as by the human sitting in the room in FIG. 6, the control circuitry 220 and/or 228 may then determine whether the speech is intelligible at 2320.

If a determination is made that the speech is not intelligible, then the process may move to block 2350 where the control circuitry 220 and/or 228 may remove ambient sound in an attempt to make the speech intelligible. Once ambient sound is removed, the control circuitry 220 and/or 228 y may again test the speech to determine whether becomes intelligible after the removal of the ambient sounds. If a determination is made that the speech is still not intelligible, then the control circuitry 220 and/or 228, at block 2360, may remove sound effects such as effects of other sound sources that affect the acoustics of the human speech. After removing the sound effects, at block 2320, the control circuitry 220 and/or 228 may again test if the speech has become intelligible after the removal of sound effects. If a determination is made that the speech is still not intelligible, then the control circuitry 220 and/or 228 may remove any occlusions that were integrated into the metadata which may have contributed to making the sound intelligible. For example, an occlusion, such as the wall, may cause the speech to be muffled and as make it unintelligible. As such the conclusion may be removed and the speech may be tested again at block 2320 to determine if has become intelligible after the removal of occlusion spatial data. If a determination is made that the speech is still unintelligible, then the control circuitry 220 and/or 228 at block 2380 may remove all sounds outside of the human speech and once again test if the speech is intelligible. Although a sequence has been described where block 2350 ambient noise sound was removed and subsequently other sound effects and occlusions were removed, the embodiments are not so limited and the control circuitry 220 and/or 228 may by removing any of the sound or sound effects 2350-2380 to determine if the speech becomes intelligible after their removal and may retest for intelligibility in any order.

If a determination is made at block 2320 the speech is intelligible, then the process may end at block 2340, or a positive determination may be made that the speech is intelligible.

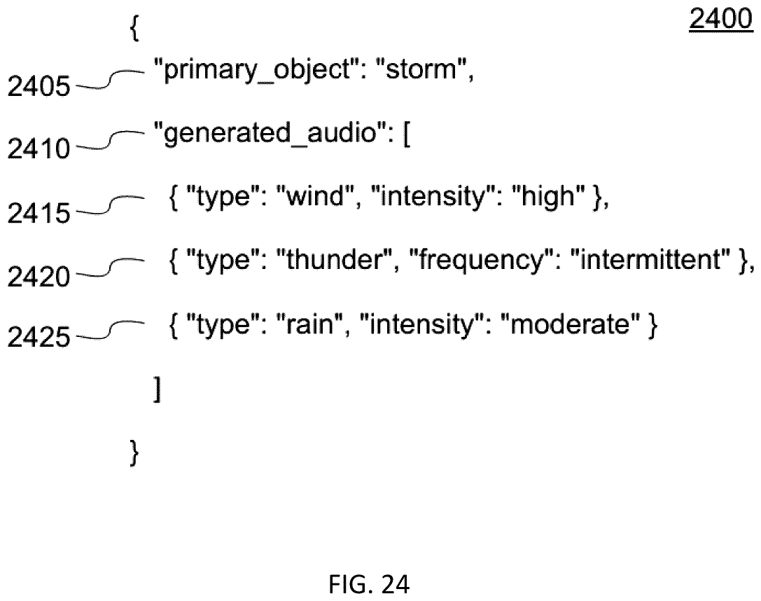

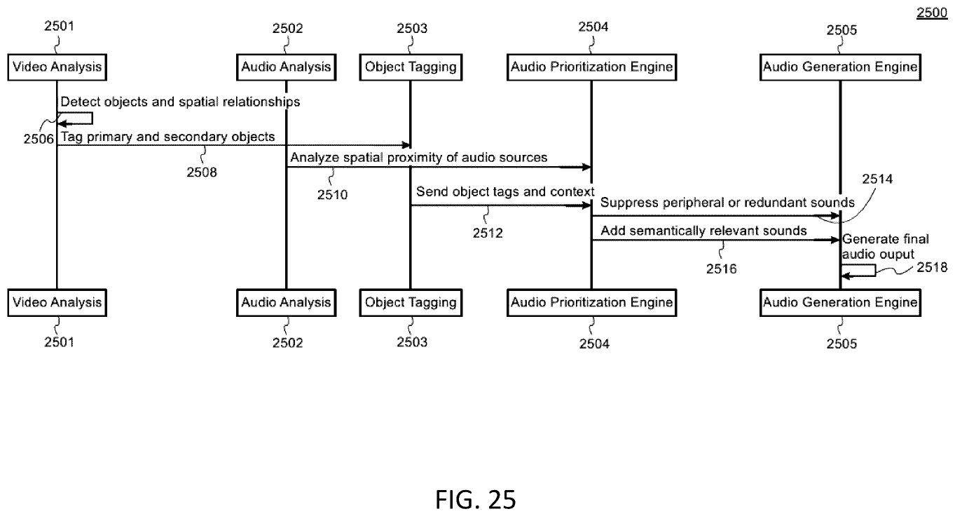

FIG. 24 is an example of a JSON structure for considering peripheral sounds when generating spatial audio tracks for sound sources, in accordance with some embodiments of the disclosure and FIG. 25 is a sequence diagram of a process 2500 for considering peripheral sounds when generating spatial audio tracks for sound sources, in accordance with some embodiments of the disclosure.

In some embodiments, the control circuitry 220 and/or 228 may prioritize audio object generation based on spatial proximity and semantic similarity to other objects. This type of prioritization may prevent unnecessary audio generation for peripheral or less relevant sound sources while enhancing coherence and immersion. To prioritize audio object generation based on spatial proximity and semantic similarity to other objects, the control circuitry 220 and/or 228 may utilize various modules, such as modules 2501-2505. These modules may include a video analysis module 2501, audio analysis module 2502, object tagging module 2503, audio prioritizing engine 2504, and audio generation engine 2505. The video analysis module 2501 may perform analysis to detect sound sources within a scene or segment and determine spatial relationships between the sound sources and other objects within the scene or segment, the audio analysis module 2502 may analyze spatial proximity of audio sources, i.e. the sound sources, the object tagging module 2503 may tag sound sources based on their context, the audio prioritizing engine 2504 may suppress peripheral or redundant sounds and add semantic relevant sounds as needed, and the audio generation engine 2505 may generate final audio output, e.g., the final audio spatial track.

The process may include the control circuitry 220 and/or 228, at 2506, using the video analysis module 2501, identifying key objects, such as main characters, using video analysis and object tagging. For instance, in a scene with a character playing pinball in an arcade, the control circuitry 220 and/or 228 may tag, at 2508, using the object tagging module 2503, the character's pinball machine as a primary object and other machines as secondary. Audio generation may then be focused on the primary object, suppressing ambient noise from the secondary machines.

The audio analysis module of 2502 may transmit data relating to the analyzed audio of the scene or segment to the audio prioritization engine 2504. The audio prioritization engine, having received this data, may analyze spatial proximity of the audio sources, i.e., sound sources, based on the audio analysis performed by the audio analysis module 2502. The audio prioritization engine 2504 may also receive object tagging performed by the object tagging module 2503. Based on the received data, the audio prioritization engine 2504 may prioritize which sound sources are to take priority in terms of generating spatial audio and which sound sources' sound is to be suppressed.

At 2514 and 2516, the audio generation engine may receive prioritization input from the audio prioritization engine 2504 and suppress peripheral or redundant sounds. It may also add semantically relevant sounds at 2516 and generate the final audio output at 2518. The JSON structure in FIG. 24 is an example of identifying a primary sound source, which in this example, is a storm, as indicated at 2405. Accordingly, wind, thunder, and rain, which relate to the primary object (the storm), may take priority over other sound sources.

In the embodiments discussed above, the term automatically relates to performing an action performed by the system or control circuitry 220 and/or 228 without user intervention. In some embodiments, such as in FIGS. 10, 12, 14, 16, 18, 20, 22, and 25, although a reference may be made to the control circuitry 220 and/or 228 using or leveraging various modules for performing a task or part of the process, the embodiments are not so limited and include the control circuitry 220 and/or 228 performing the task or process itself or using other processing circuitry or a server to perform the task of process.

The embodiments described above also describe a method for automatically generating a spatial soundtrack by accessing a media asset that includes a plurality of segments. The control circuitry 220 and/or 228 performs an analysis of a segment, from the plurality of segments, of the media asset, such as in real time. The analysis may be any type of analysis described in FIGS. 1, 4-5, 10, 12, 14, 16, 18, 20, 22, and 25. Based on the analysis, the control circuitry 220 and/or 228 may identify for the at least one sound source in the segment, one or more of the sound source's acoustic properties, and one or more surrounding environmental conditions that affect the one or more acoustic properties of the identified sound producing object. The control circuitry 220 and/or 228 then determines a score for the sound source based on one or more factors and automatically generates a spatial audio track for the identified sound source based on its determined score and the one or more surrounding environmental conditions. As described earlier, the automatically generated spatial audio track is a spatialized component of sound produced by the sound source. In some embodiments, when the sound source is a moving sound source, the control circuitry 220 and/or 228 may analyze a plurality of video frames using a computational model, perform pixel-level segmentation across the plurality of video frames to identify the at least one sound source, obtain spatial coordinates of the at least one sound source in a first frame, from the plurality of video frames, and track the trajectory of the at least one sound source across the plurality of video frames. In some embodiments, when there are multiple sound sources, such as a first and second sound source, the control circuitry 220 and/or 228 may determine that the score of a first sound source is above a threshold score and that the score of a second sound source is below the threshold score. In this scenario, the control circuitry 220 and/or 228 may categorize the first sound source as a high fidelity object and the second sound source as a low fidelity object. The control circuitry 220 and/or 228 may then perform a detailed spatialization of the first sound source which is categorized as a high fidelity object and either perform a partial specialization or not performing any specialization for the second sound source which is categorized as a low fidelity object. In this scenario, the wherein partial spatialization may utilize data from a previous spatialization performed on the second sound source.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

In some embodiments, the processes have been described in a particular order or sequence. However, the embodiments are not so limited any other order or sequence, or repetition of steps, are also contemplated within the embodiments.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for automatically generating a spatial soundtrack comprising:
accessing a media asset comprising a plurality of segments;
performing an analysis of a segment, from the plurality of segments, of the media asset;
based on the analysis, identifying at least one sound source in the segment, one or more of the sound source's acoustic properties, and one or more surrounding environmental conditions that affect the one or more acoustic properties of the identified sound producing object;
determining a score for the sound source based on one or more factors; and
automatically generating a spatial audio track for the identified sound source by adjusting an intensity of based on its determined score and the one or more surrounding environmental conditions based on the determined score to maintain clarity of the sound source, wherein the automatically generated spatial audio track is a spatialized component of sound produced by the sound source.

2. The method of claim 1, wherein the analysis performed on the segment of the media asset comprises at least one of: video analysis, audio analysis, closed caption analysis, contextual analysis, or any combination thereof.

3. The method of claim 2, wherein the video analysis comprises:
analyzing a plurality of video frames using a computational model; and
performing pixel-level segmentation across the plurality of video frames to identify the at least one sound source.

4. The method of claim 3, further comprising:
obtaining spatial coordinates of the at least one sound source in a first frame, from the plurality of video frames; and
tracking a trajectory of the at least one sound source across the plurality of video frames.

5. (canceled)

6. The method of claim 1, further comprising:
determining an occurrence of a triggering event in the media asset; and
performing the analysis on the segment to identify the at least one sound source in response to the occurrence of the triggering event.

7. The method of claim 1, wherein the one or more factors for determining the score includes a) prominence of the sound source and b) relevance of the sound source to a context of the segment.

8. The method of claim 1, wherein the one or more surrounding environmental conditions comprise at least one of: occlusion, reverberation, echo, delay or a weather related sound comprising any one of: rain, wind, thunder, lightning, or any combination thereof.

9-10. (canceled)

11. The method of claim 1, further comprising:
determining that the score of a first sound source, from the at least one identified sound sources, is above a threshold score and that the score of a second sound source, from the identified at least one sound sources, is below the threshold score; and
in response to determining that the score of a first sound source is above a threshold score and the score of a second sound source is below the threshold score, categorizing the first sound source as a high fidelity object and the second sound source as a low fidelity object.

12. The method of claim 11, further comprising, performing a detailed spatialization of the first sound source which is categorized as a high fidelity object and either performing a partial specialization or bypassing a spatialization for the second sound source which is categorized as a low fidelity object.

13. (canceled)

14. The method of claim 1, further comprising:
identifying a first and a second sound source, from the at least one sound source in the segment;
determining whether to prioritize processing of the first or the second sound source for determining its acoustic properties and generating the spatial audio track; and
prioritizing the first sound source over the second sound source based on the first sound source's spatial proximity and semantic similarity being higher relative to an object of relevance in the segment than the second sound source.

15. The method of claim 1, further comprising:
determining that the first sound source includes a dialogue;
determining dialogue intelligibility based on speech-to-text analysis of the dialogue; and
in response to determining, based on the speech-to-text analysis, that a transcription accuracy of the dialogue is below a predefined intelligibility threshold due to presence of a background sound:
limiting or eliminating the background sound until the transcription accuracy of the dialogue exceeds the predefined intelligibility threshold.

16. A system for automatically generating a spatial soundtrack comprising:
communication circuitry configured to access a media asset comprising a plurality of segments; and
control circuitry configured to:
perform an analysis of a segment, from the plurality of segments, of the media asset;
based on the analysis, identify at least one sound source in the segment, one or more of the sound source's acoustic properties, and one or more surrounding environmental conditions that affect the one or more acoustic properties of the identified sound producing object;
determine a score for the sound source based on one or more factors; and
automatically generate a spatial audio track for the identified sound source by adjusting an intensity of based on its determined score and the one or more surrounding environmental conditions based on the determined score to maintain clarity of the sound source, wherein the automatically generated spatial audio track is a spatialized component of sound produced by the sound source.

17. The system of claim 16, wherein the analysis performed by the control circuitry on the segment of the media asset comprises at least one of: video analysis, audio analysis, closed caption analysis, contextual analysis, or any combination thereof.

18. The system of claim 17, wherein the video analysis comprises, the control circuitry configured to:
analyze a plurality of video frames using a computational model; and
perform pixel-level segmentation across the plurality of video frames to identify the at least one sound source.

19. The system of claim 18, further comprising, the control circuitry configured to:
obtain spatial coordinates of the at least one sound source in a first frame, from the plurality of video frames; and
track a trajectory of the at least one sound source across the plurality of video frames.

20. (canceled)

21. The system of claim 16, further comprising, the control circuitry configured to:
determine an occurrence of a triggering event in the media asset; and
perform the analysis on the segment to identify the at least one sound source in response to the occurrence of the triggering event.

22. The system of claim 16, wherein the one or more factors for determining the score by the control circuitry includes a) prominence of the sound source and b) relevance of the sound source to a context of the segment.

23. The system of claim 16, wherein the one or more surrounding environmental conditions comprise at least one of: occlusion, reverberation, echo, delay or a weather related sound comprising any one of: rain, wind, thunder, lightning, or any combination thereof.

24-25. (canceled)

26. The system of claim 16, further comprising, the control circuitry configured to:
determine that the score of a first sound source, from the at least one identified sound sources, is above a threshold score and that the score of a second sound source, from the identified at least one sound sources, is below the threshold score; and
in response to determining that the score of a first sound source is above a threshold score and the score of a second sound source is below the threshold score, categorize the first sound source as a high fidelity object and the second sound source as a low fidelity object.

27. The system of claim 27, further comprising, the control circuitry configured to perform a detailed spatialization of the first sound source which is categorized as a high fidelity object and either performing a partial specialization or bypassing a spatialization for the second sound source which is categorized as a low fidelity object.

28. (canceled)

29. The system of claim 16, further comprising, the control circuitry configured to:
identify a first and a second source, from the at least one sound source in the segment;
determine whether to prioritize processing of the first or the second sound source for determining its acoustic properties and generating the spatial audio track; and
prioritize the first sound source over the second sound source based on the first sound source's spatial proximity and semantic similarity being higher relative to an object of relevance in the segment than the second sound source.

30. The system of claim 16, further comprising, the control circuitry configured to:
determine that the first sound source includes a dialogue;
determine dialogue intelligibility based on performing a speech-to-text analysis of the dialogue; and
in response to determining, based on the speech-to-text analysis, that a transcription accuracy of the dialogue is below a predefined intelligibility threshold due to presence of a background sound:
limit or eliminate the background sound until the transcription accuracy of the dialogue exceeds the predefined intelligibility threshold.
